(19) United States
(12) Patent Application Publication
(10) Pub. No.: US 2013/0020739 A1
(43) Pub. Date: Jan. 24, 2013

(54) FLEXOGRAPHIC PRINTING PLATE PRECURSOR FOR LASER ENGRAVING

(71) Applicant: Katsuhiro Yamashita, Haibara-gun (JP)

(72) Inventor: Katsuhiro Yamashita, Haibara-gun (JP)

(73) Assignee: FUJIFILM CORPORATION, Minato-ku, Tokyo (JP)

(21) Appl. No.: 13/638,489

(22) PCT Filed: Mar. 28, 2011
(86) PCT No.: PCT/JP2011/057607

§ 371 Date: Sep. 28, 2012

(30) Foreign Application Priority Data
Mar. 29, 2010 (JP) 2010-074176

(51) Int. Cl. C08F 293/00; C08L 53/02; B29C 35/08; C08K 3/04

(52) U.S. Cl. 264/400; 525/59

(57) ABSTRACT

The flexographic printing plate precursor for laser engraving of the present invention includes, above a support, a crosslinked relief-forming layer formed by subjecting a resin composition containing a chain-polymerizable monomer (A), a crosslinking agent (B) that crosslinks in a step-growth reaction, and a crosslinkable polymer (C) having a crosslinkable group that reacts with the crosslinking agent (B) to chain polymerization and step-growth crosslinking reactions, the crosslinked relief-forming layer having a storage modulus E′ (MPa) at a frequency of 100 Hz and 25° C. satisfying the relationship (a) below and having a maximum tensile elongation L (%) at break at 25° C. satisfying the relationship (b) below.

1≦E′≦30 (a)

30≦L≦300 (b)

### TECHNICAL FIELD

The present invention relates to a flexographic printing plate precursor for laser engraving.

### BACKGROUND ART

In flexographic printing, ink attached to an upper part of a flexographic relief plate is transferred to a printing substrate by pressing the flexographic relief plate against the printing substrate while adjusting the distance (printing pressure) between the flexographic relief plate and the printing substrate. In this process, the relief shape of the flexographic relief plate is pressed and deforms according to the printing pressure. Since the printing pressure actually applied to a projecting part varies depending on film thickness non-uniformity, the amount of the surrounding area engraved, and the way in which printing pressure conditions are set, it is desirable for the relief shape to have a sufficient height and a rectangular shape.

Therefore, in order to realize a high resolution image in flexographic printing, it is preferable to form a fine and high relief shape (small-dot high-aspect ratio relief shape).

Patent Document 1 discloses a method for producing a flexographic relief plate having a small-dot high-aspect ratio relief shape by solvent development via mask exposure.

Patent Document 2 discloses a method for producing a flexographic relief plate by laser engraving in order to obtain a desired relief shape.

### PRIOR ART DOCUMENTS

### Patent Documents

Patent Document 1: JP-A-2003-533738 (JP-A denotes a Japanese unexamined patent application publication)
Patent Document 2: JP-A-2004-506551

### SUMMARY OF THE INVENTION

### Problems to be Solved by the Invention

However, it is difficult to form a desired relief shape by the method described in Patent Document 1. This is because it is difficult to establish spatial discrimination in curing of a printing plate precursor using mask exposure, and it is also difficult to dissolve only an uncured part using a solvent.

Furthermore, a laser generally used in production of a flexographic relief plate by laser engraving such as that described in Patent Document 2 is a high output carbon dioxide laser, which is unsuitable for high resolution image formation due to it having a long wavelength of 10,600 nm.

Furthermore, a diode laser (DL) is known as a laser having a shorter wavelength than that of a carbon dioxide laser, small size, and low cost, but since it has a low output compared with a carbon dioxide laser, there is the problem that productivity of relief formation by laser engraving is insufficient and, furthermore, it has been found that, if the amount of heat that makes laser engraving possible is applied to a flexographic plate precursor, since the surrounding area melts due to the heat it is very difficult to form a small-dot high-aspect ratio shape.

Moreover, it is obvious that merely forming a desired small-dot high-aspect ratio relief shape does not by itself make application to flexographic printing possible. In the case of a small-dot high-aspect ratio relief shape, the property of being resistant to a locally concentrated load is preferable. Furthermore, if the amount of deformation due to a load is large, it is difficult to obtain a high resolution image. On the other hand, it has been found that a solid printed area also preferably has the flexibility to enable it to sufficiently follow the surface shape of a printing substrate.

While taking into consideration the above-mentioned requirements, it is an object of the present invention to provide a high resolution flexographic printing plate precursor for laser engraving that achieves a balance between the engraving properties for a fine projecting shape and the printing properties thereof.

Specifically, it is one object of the present invention to provide a flexographic printing plate precursor that can form a small-dot high-aspect ratio relief shape that is compatible with high resolution printing.

It is another object of the present invention to provide a flexographic printing plate precursor having a crosslinked relief-forming layer that has improved small point breakage frequency and a wide allowance for ink laydown with respect to printing pressure.

It is yet another object of the present invention to provide a flexographic printing plate precursor having a crosslinked relief-forming layer exhibiting high rinsing properties and a suppressed presence of residue.

### Means for Solving the Problems

The above-mentioned objects of the present invention have been attained by means <1> or <9> below. They are listed together with <2> to <8> and <10>, which are preferred embodiments.

<1> A flexographic printing plate precursor for laser engraving comprising, above a support, a crosslinked relief-forming layer formed by subjecting a resin composition comprising a chain-polymerizable monomer (A), a crosslinking agent (B) that crosslinks in a step-growth reaction, and a crosslinkable polymer (C) having a crosslinkable group that reacts with the crosslinking agent (B) to chain polymerization and step-growth crosslinking reactions, the crosslinked relief-forming layer having a storage modulus E′ (MPa) at a frequency of 100 Hz and 25° C. satisfying the relationship (a) below and having a maximum tensile elongation L (%) at break at 25° C. satisfying the relationship (b) below,

1≦E′≦30 (a)

30≦L≦300 (b)

<2> the flexographic printing plate precursor for laser engraving according to <1>, wherein the chain-polymerizable monomer (A) is a polyfunctional ethylenically unsaturated compound (A1),
<3> the flexographic printing plate precursor for laser engraving according to <2>, wherein the chain-polymerizable monomer (A) is a polyfunctional ethylenically unsaturated compound having a saturated bridged ring structure,
<4> the flexographic printing plate precursor for laser engraving according to any one of <1> to <3>, wherein the crosslinking agent (B) that crosslinks in a step-growth reaction is selected from the group consisting of a polyfunctional isocyanate compound (B1), a polyfunctional acid anhydride (B2), and a hydrolyzable silyl group- and/or silanol group-containing compound (B3),
<5> the flexographic printing plate precursor for laser engraving according to any one of <1> to <4>, wherein the crosslinkable polymer (C) has a glass transition temperature (Tg) of at least 20° C.,
<6> the flexographic printing plate precursor for laser engraving according to <5>, wherein the crosslinkable polymer (C) is a polyvinyl acetal or acrylic resin having a hydroxy group or an amino group having at least one hydrogen atom bonded to the nitrogen atom,
<7> the flexographic printing plate precursor for laser engraving according to any one of <1> to <6>, wherein the crosslinked relief-forming layer further comprises carbon black,
<8> the flexographic printing plate precursor for laser engraving according to any one of <1> to <7>, wherein it further comprises a compound whose conjugate acid has an acid dissociation constant (pKa) of 11 to 13,
<9> the flexographic printing plate precursor for laser engraving according to any one of <1> to <8>, wherein the crosslinked relief-forming layer has a thermal decomposition temperature (Td) satisfying the relationship (c) below, and the crosslinked relief-forming layer has a softening temperature (Tm) that is at least 200° C. or satisfies the relationship (d) below,

150° C.≦Td≦350° C. (c)

Td≦Tm (d)

<10> a process for making a flexographic printing plate comprising a step of laser-engraving the flexographic printing plate precursor according to any one of <1> to <9> and a step of washing the laser-engraved printing plate with water or an aqueous solution, and
<11> the process for making a flexographic printing plate according to <10>, wherein the aqueous solution comprises an amphoteric surfactant.

### Effects of the Invention

The flexographic printing plate precursor of the present invention can give a crosslinked relief-forming layer in which a fine projecting shape can be engraved and which can give the printing characteristics thereof. In particular, a crosslinked relief-forming layer having desired physical properties can be obtained by mainly carrying out a chain-transfer polymerization reaction and then carrying out a crosslinking reaction by step-growth polymerization. These crosslinked relief-forming layers can be controlled so as to have preferred physical properties such as printing suitability even for a small-dot high-aspect ratio relief shape.

### BRIEF DESCRIPTION OF DRAWINGS

FIG. 1A diagram schematically showing a cross-section of a small point (small dot) of a flexographic printing plate.

### MODES FOR CARRYING OUT THE INVENTION

The flexographic printing plate precursor for laser engraving (hereinafter, also simply called a ‘flexographic printing plate precursor’ or a ‘relief printing plate precursor’) of the present invention is explained in detail below.

The flexographic printing plate precursor of the present invention comprises, above a support, a crosslinked relief-forming layer formed by subjecting a resin composition comprising a chain-polymerizable monomer (A), a crosslinking agent (B) that crosslinks in a step-growth reaction, and a crosslinkable polymer (C) having a crosslinkable group that reacts with the crosslinking agent (B) to chain polymerization and step-growth crosslinking reactions, the crosslinked relief-forming layer having a storage modulus E′ (MPa) at a frequency of 100 Hz and 25° C. satisfying the relationship (a) below and having a maximum tensile elongation L (%) at break at 25° C. satisfying the relationship (b) below.

1≦E′≦30 (a)

30≦L≦300 (b)

The flexographic printing plate precursor of the present invention comprises a crosslinked relief-forming layer above a support. This crosslinked relief-forming layer is produced by applying the above resin composition comprising (A) to (C) onto a support and crosslinking it.

### <Support>

First, the support is explained below.

The shape of the support may be a sheet shape or a sleeve shape, and it is mainly a sheet-shaped support that is explained. Materials that can be used for the support are explained later.

A crosslinked relief-forming layer formed above the above-mentioned support is formed by subjecting a resin composition comprising a chain-polymerizable monomer (A), a crosslinking agent (B) that crosslinks in a step-growth reaction, and a crosslinkable polymer (C) having a crosslinkable group that reacts with the crosslinking agent (B) to chain polymerization and step-growth crosslinking reactions. The above-mentioned crosslinked relief-forming layer has both a crosslinked structure based on chain polymerization of the chain-polymerizable monomer (A) and a crosslinked structure based on step-growth polymerization.

The above-mentioned three components A, B, and C, the chain polymerization reaction, and the step-growth polymerization reaction are explained below.

The chain-polymerizable monomer (A) is a monomer that polymerizes in a chain growth manner; it includes a radically polymerizable monomer and a cationically polymerizable monomer, but is preferably a radically polymerizable monomer.

The chain-polymerizable monomer (A) is preferably a polyfunctional ethylenically unsaturated compound (Al). Details are explained later.

Chain polymerization is known to a person skilled in the art; in contrast to step-growth polymerization it is a polymerization reaction that progresses based on a chain mechanism in which the chain grows by a monomer reacting with an active site at a growing chain terminal, and as a result a similar active site is generated.

The crosslinking agent (B) and the crosslinkable polymer (C) are crosslinked by a step-growth polymerization reaction. The step-growth polymerization reaction is also known to a person skilled in the art, and a representative thereof is polycondensation or polyaddition. In step-growth polymerization, not only are all of the crosslinking agent (B) and the crosslinkable polymer (C) involved in a polymer formation reaction at the same time, but oligomers formed during the reaction process also have reactive groups and react with each other.

The chain polymerization reaction and the step-growth polymerization reaction are described in for example ‘Kisokoubunshikagaku (Basic Polymer Science)’ 2^{nd} edition, 2006, Ed. by The Society of Polymer Science, Japan, published by Tokyo Kagaku Dojin.

A crosslinked structure based on chain polymerization is preferably formed by polymerization of the above-mentioned resin composition, which preferably comprises a radically polymerizable monomer and more preferably a polyfunctional ethylenically unsaturated compound, in the presence of a polymerization initiator, which is an optional component.

A crosslinking reaction based on a step-growth polymerization reaction is preferably based on polyaddition or polycondensation, and is more preferably based on polyaddition. This crosslinking reaction is due to a reaction between a crosslinkable group-containing crosslinking agent (B) and a crosslinkable polymer (C) containing a crosslinkable group that reacts with the crosslinking agent (B).

The crosslinking reaction based on chain polymerization and the crosslinking reaction based on step-growth polymerization may progress at the same time or either one thereof may take place first in stepwise reactions.

First, the chain-polymerizable monomer, which is preferably a radically polymerizable monomer and more preferably an ethylenically unsaturated compound (A1), is explained.

### <Chain-Polymerizable Monomer (A), Polyfunctional Ethylenically Unsaturated Compound (A1)>

In the present invention, the chain-polymerizable monomer is preferably a radically polymerizable monomer that undergoes addition polymerization by means of a radical polymerization initiating species, is more preferably a compound having at least one radical addition-polymerizable ethylenically unsaturated group, and is particularly preferably a polyfunctional ethylenically unsaturated compound (A1) having at least two thereof.

The radically polymerizable monomer is explained in further detail below.

The radically polymerizable monomer that can be used in the present invention comprises an ethylenically unsaturated compound containing at least one ethylenically unsaturated group. This radically polymerizable monomer is preferably a polyfunctional ethylenically unsaturated compound having at least one, and preferably two, ethylenically unsaturated groups at the molecular terminal. Such a group of compounds is widely known in the related industrial field, and they may be used without any particular restriction in the present invention.

The radically polymerizable monomer may be of any chemical form such as a monomer, a prepolymer, that is, a dimer, a trimer, or an oligomer, a copolymer thereof, or a mixture thereof.

Examples of the monomer include an unsaturated carboxylic acid (e.g. acrylic acid, methacrylic acid, itaconic acid, crotonic acid, isocrotonic acid, maleic acid, etc.), an ester thereof, and an amide. It is preferable to use an ester of an unsaturated carboxylic acid and an aliphatic polyhydric alcohol compound or an amide of an unsaturated carboxylic acid and an aliphatic polyvalent amine compound.

Furthermore, it is also desirable to use an addition reaction product of an unsaturated carboxylic acid ester or amide having a nucleophilic substituent such as a hydroxy group, an amino group or a mercapto group with a monofunctional or polyfunctional isocyanate or epoxy, or a dehydration-condensation reaction product of the carboxylic acid ester or amide with a monofunctional or polyfunctional carboxylic acid.

It is also desirable to use an addition reaction product of an unsaturated carboxylic acid ester or amide having an electrophilic substituent such as an isocyanato group or an epoxy group with a monofunctional or polyfunctional alcohol, an amine or a thiol, or a substitution reaction product of an unsaturated carboxylic acid ester or amide having a leaving group such as a halogen atom or a tosyloxy group with a monofunctional or polyfunctional alcohol, amine or tiol. As another example, it is possible to use a group of compounds in which the above-mentioned unsaturated carboxylic acid (ester) is replaced by an unsaturated phosphonic acid, styrene, vinyl ether, etc.

The polyfunctional ethylenically unsaturated compound (A1) is explained below.

Examples of the polyfunctional monomers include esters of an unsaturated carboxylic acid and a polyvalent aliphatic alcohol, and specific examples of them include, as acrylic acid esters, ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl)ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl)isocyanurate, and a polyester acrylate oligomer.

Examples of methacrylic acid esters include tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane, and bis[p-(methacryloxyethoxy)phenyl]dimethylmethane.

Examples of itaconic acid esters include ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate.

Examples of crotonic acid esters include ethylene glycol dicrotonate, tetramethylene glycol dicrotonate, pentaerythritol dicrotonate, and sorbitol tetradicrotonate.

Examples of isocrotonic acid esters include ethylene glycol diisocrotonate, pentaerythritol diisocrotonate, and sorbitol tetraisocrotonate.

Examples of maleic acid esters include ethylene glycol dimaleate, triethylene glycol dimaleate, pentaerythritol dimaleate, and sorbitol tetramaleate.

As examples of other esters, for example, aliphatic alcohol-based esters described in JP-B-46-27926 (JP-B denotes a Japanese examined patent application publication), JP-B-51-47334, and JP-A-57-196231, those having an aromatic skeleton described in JP-A-59-5240, JP-A-59-5241, and JP-A-2-226149, and those containing an amino group described in JP-A-1-165613 may suitably be used.

The above-mentioned ester-based polyfunctional ethylenically unsaturated compounds may be used on their own or as a mixture of two or more types thereof.

Furthermore, specific examples of amide monomers of an aliphatic polyamine compound and an unsaturated carboxylic acid include methylenebisacrylamide, methylenebismethacrylamide, 1,6-hexamethylenebisacrylamide, 1,6-hexamethylenebismethacrylamide, diethylenetriaminetrisacrylamide, xylylenebisacrylamide, and xylylenebismethacrylamide.

Preferred examples of other amide-based polyfunctional ethylenically unsaturated compounds include those having a cyclohexylene structure described in JP-B-54-21726.

Furthermore, a urethane-based addition-polymerizable compound produced by an addition reaction of an isocyanate group and a hydroxy group is also suitable as a polyfunctional ethylenically unsaturated compound, and specific examples thereof include urethane-based polyfunctional ethylenically unsaturated compounds comprising two or more groups per molecule in which a hydroxy group-containing ethylenically unsaturated compound represented by Formula (A) below is added to a polyisocyanate compound having two or more isocyanate groups per molecule described in JP-B-48-41708.

CH₂═C(R)COOCH₂CH(R′)OH (A)

wherein R and R′ independently denote H or CH₃.

Furthermore, urethane acrylates described in JP-A-51-37193, JP-B-2-32293, and JP-B-2-16765, and urethane-based polyfunctional ethylenically unsaturated compounds having an ethylene oxide chain described in JP-B-58-49860, JP-B-56-17654, JP-B-62-39417, JP-B-62-39418 are also suitable.

Furthermore, by use of an addition-polymerizable compound having an amino structure or a sulfide structure in the molecule described in JP-A-63-277653, JP-A-63-260909, and JP-A-1-105238, a crosslinked resin composition can be obtained in a short time.

Other examples of polyfunctional ethylenically unsaturated compounds include polyester acrylates such as those described in JP-A-48-64183, JP-B-49-43191, and JP-B-52-30490, and polyfunctional acrylates and methacrylates such as epoxy acrylates formed by a reaction of an epoxy resin and (meth)acrylic acid. Examples also include specific unsaturated compounds described in JP-B-46-43946, JP-B-1-40337, and JP-B-1-40336, and vinylphosphonic acid-based compounds described in JP-A-2-25493. In some cases, perfluoroalkyl group-containing structures described in JP-A-61-22048 are suitably used. Moreover, those described as photocuring monomers or oligomers in the Journal of the Adhesion Society of Japan, Vol. 20, No. 7, pp. 300 to 308 (1984) may also be used.

As the polyfunctional ethylenically unsaturated compound, a compound having a large number of ethylenically unsaturated groups per molecule is preferable, and a di- or higher-functional polyfunctional ethylenically unsaturated compound is preferably used.

Furthermore, in order to increase the strength of a crosslinked relief-forming layer, the number of ethylenically unsaturated groups per molecule is preferably at least two, and more preferably at least three. Moreover, in accordance with the use of those having different numbers of functional groups and/or different polymerizable groups (e.g. acrylic acid ester, methacrylic acid ester, styrene-based compound, vinyl ether-based compound) in combination, it is possible to control the storage modulus E′ or the maximum tensile elongation L at break of a crosslinked relief-forming layer. The radically polymerizable monomer is preferably used in a range of 10 to 60 mass % relative to nonvolatile components in the resin composition, and more preferably 15 to 40 mass %. It may be used on its own or in a combination of two or more types. In accordance with the use of a radically polymerizable monomer, film physical properties such as for example brittleness and flexibility may be adjusted.

In the present invention, from the viewpoint of achieving a balance between film flexibility and engraving sensitivity, it is preferable to use in combination at least one of each of a polyfunctional ethylenically unsaturated compound containing a plurality of polymerizable groups (also called a ‘polyfunctional monomer’) and a monofunctional ethylenically unsaturated compound containing only one polymerizable group (also called a ‘monofunctional monomer’).

Before and/or after laser engraving, the resin composition for a relief-forming layer comprising a radically polymerizable monomer is polymerized and crosslinked by means of energy such as light or heat.

Preferred specific examples of radically polymerizable monomers that can be used in the resin composition for a relief-forming layer used in the present invention include, but are not limited to, those listed below.

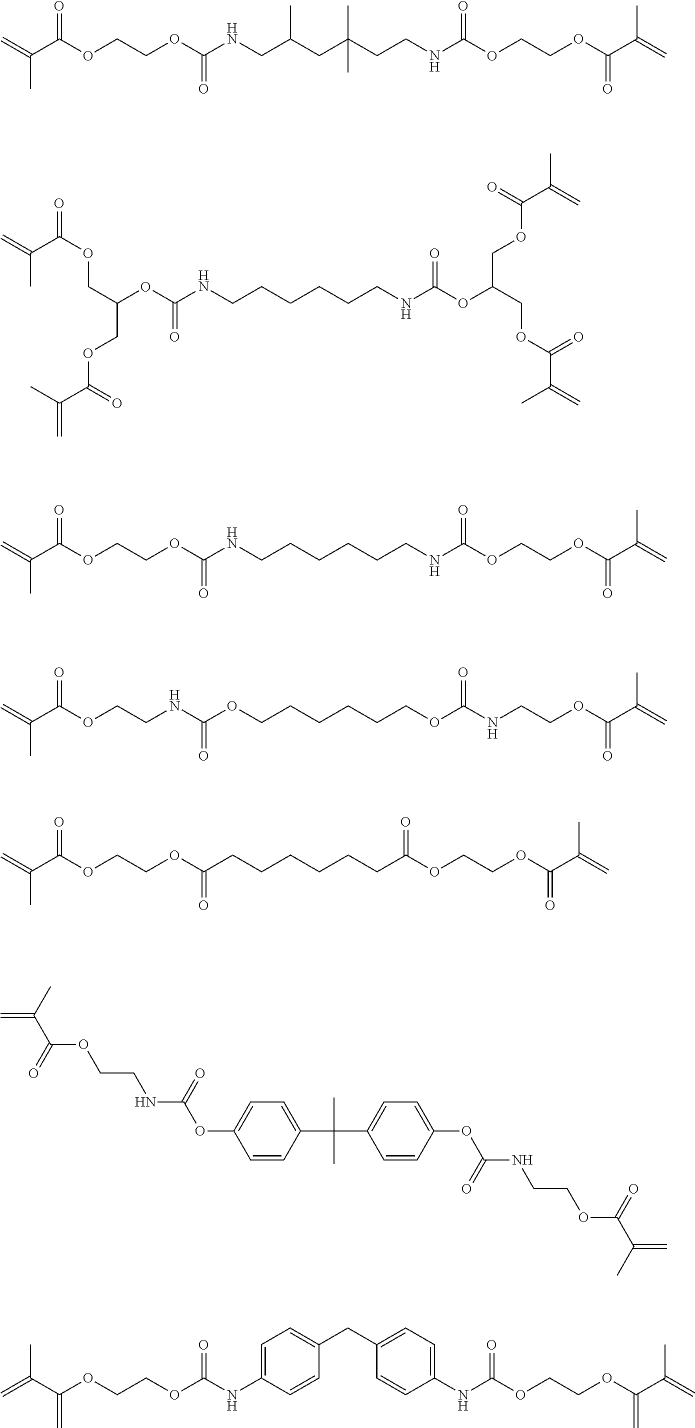

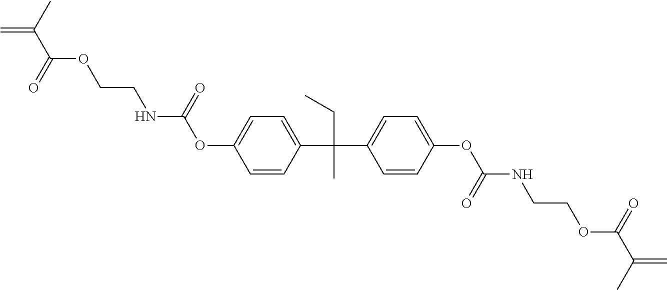 [SMILES: C=C(C)C(=O)OCCNC(=O)Oc1ccc(C(C)(CC)c2ccc(OC(=O)NCCOC(=O)C(=C)C)cc2)cc1]

Specific examples of a radical polymerizable compound usable in the present invention include saturated bridged cyclic polyfunctional monomers. As the saturated bridged cyclic polyfunctional monomer, the use of an alicyclic polyfunctional monomer having a condensed ring structure such as a compound having a bicyclo ring or a tricyclo ring structure having two methacryloyloxy groups or acryloyloxy groups is preferable from the viewpoint of controlling the physical properties.

Examples of the bicyclo rings or tricyclo rings include alicyclic hydrocarbon structures of a condensed ring structure such as norbornene skeleton (bicyclo[2.2.1]heptane), dicyclopentadiene skeleton (tricyclo[5.2.1.0^{2,6}]decane), adamantine skeleton (tricyclo[3.3.1.1^{3,7}]decane).

As the saturated bridged cyclic polyfunctional monomer, an amino group may be bonded to a bicyclo ring or a tricyclo ring directly, or via a aliphatic part of alkylene etc. such as methylene or ethylene. Moreover, a hydrogen atom of an alicyclic hydrocarbon group of these condensed ring structures may be substituted by an alkyl group etc.

In the present invention, the saturated bridged cyclic polyfunctional monomer is preferably an alicyclic polyfunctional monomer selected from the compounds below.

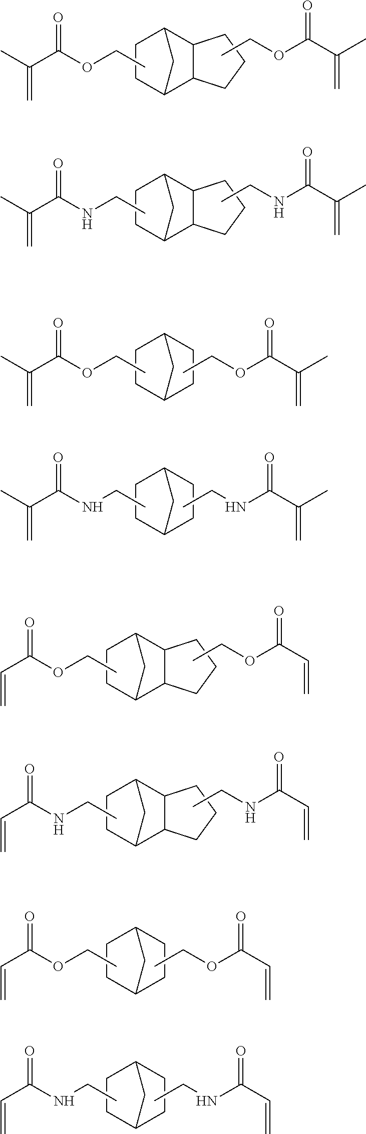

From the viewpoint of improving engraving sensitivity, it is preferable in the present invention to use as the polyfunctional monomer having an ethylenically unsaturated group a compound having a sulfur atom in the molecule.

As such an ethylenically monomer having a sulfur atom in the molecule, it is preferable from the viewpoint of improving engraving sensitivity in particular to use a polyfunctional monomer having two or more ethylenically unsaturated bonds and having a carbon-sulfur bond at a site where two ethylenically unsaturated bonds among them are linked (hereinafter, called a ‘sulfur-containing polyfunctional monomer’ as appropriate).

Examples of carbon-sulfur bond-containing functional groups of the sulfur-containing polyfunctional monomer in the present invention include sulfide, disulfide, sulfoxide, sulfonyl, sulfonamide, thiocarbonyl, thiocarboxylic acid, dithiocarboxylic acid, sulfamic acid, thioamide, thiocarbamate, dithiocarbamate, and thiourea-containing functional groups.

Furthermore, a linking group containing a carbon-sulfur bond linking two ethylenically unsaturated bonds of the sulfur-containing polyfunctional monomer is preferably at least one unit selected from —CH₂—S—, —CH₂—SS—, —NHC(═S)O—, —NH(C═O)S—, —NH(C═S)S—, and —CH₂—SO₂—.

Moreover, the number of sulfur atoms contained in the sulfur-containing polyfunctional monomer molecule is not particularly limited as long as it is one or more, and may be selected as appropriate according to the intended application, but from the viewpoint of a balance between engraving sensitivity and solubility in a coating solvent it is preferably 1 to 10, more preferably 1 to 5, and yet more preferably 1 or 2.

On the other hand, the number of ethylenically unsaturated bond sites contained in the sulfur-containing polyfunctional monomer is not particularly limited as long as it is two or more and may be selected as appropriate according to the intended application, but from the viewpoint of flexibility of a crosslinked film it is preferably 2 to 10, more preferably 2 to 6, and yet more preferably 2 to 4.

From the viewpoint of flexibility of a film that is formed, the molecular weight of the sulfur-containing polyfunctional monomer in the present invention is preferably 120 to 3,000, and more preferably 120 to 1,500.

Furthermore, the sulfur-containing polyfunctional monomer in the present invention may be used on its own or as a mixture with a polyfunctional monomer or monofunctional monomer having no sulfur atom in the molecule.

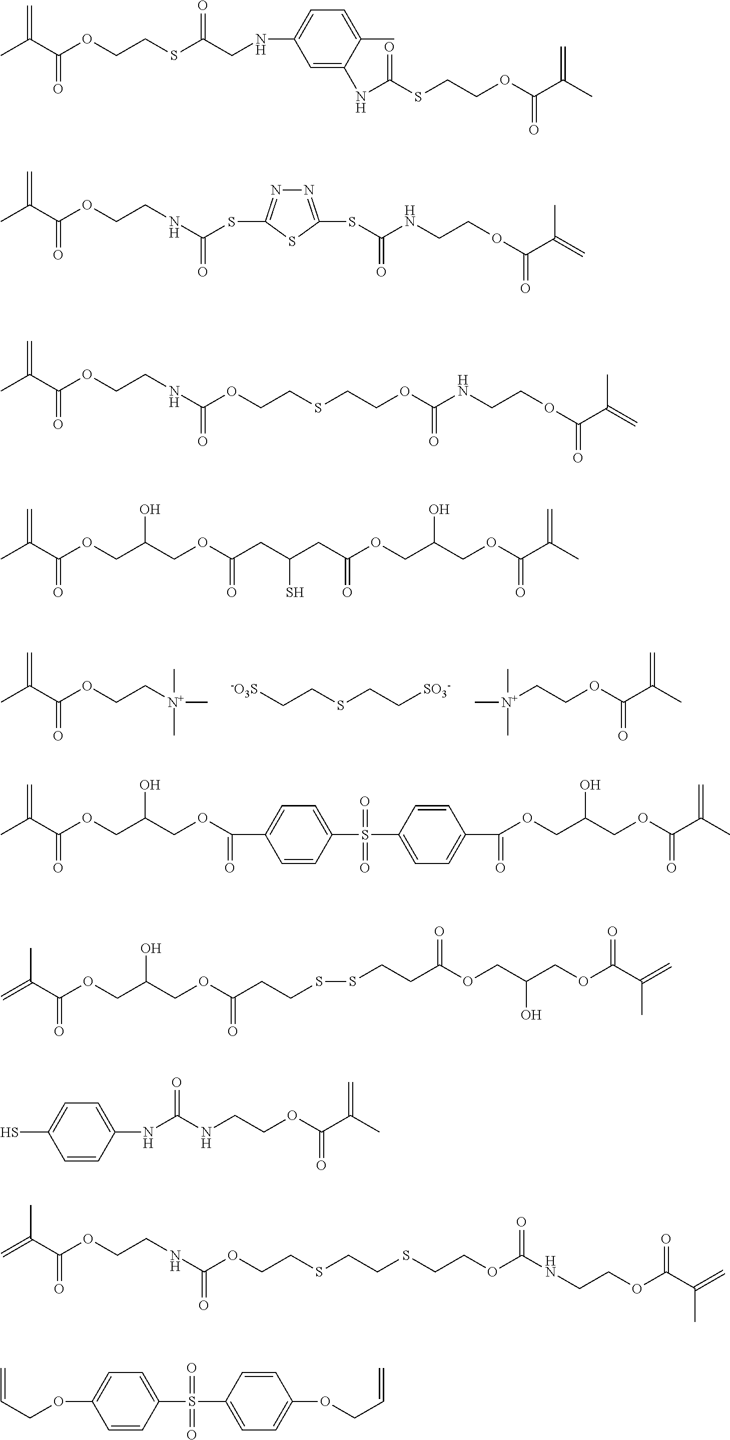

In accordance with use in the resin composition employed in the present invention of a polyfunctional monomer such as a sulfur-containing polyfunctional monomer, film physical properties such as for example brittleness and flexibility of the crosslinked relief-forming layer of a flexographic printing plate for laser engraving can be adjusted.

From the viewpoint of flexibility and brittleness of a crosslinked film, the content of the chain-polymerizable monomer (A) or the polyfunctional ethylenically unsaturated compound (A1) in the above-mentioned resin composition is preferably 5 to 60 mass % on a solids content basis, and more preferably 8 to 30 mass %.

The resin composition for the crosslinked relief-forming layer in the present invention preferably comprises a polymerization initiator (D) as an optional component, in combination with a radically polymerizable monomer as a chain-polymerizable monomer (A).

### <Polymerization Initiator (D)>

As the polymerization initiator, a radical polymerization initiator is preferable, and compounds described in paragraphs 0074 to 0118 of JP-A-2008-63554 are preferable.

Examples of the radical polymerization initiator include an aromatic ketone, an onium salt compound, an organic peroxide, a thio compound, a hexaarylbiimidazole compound, a ketoxime ester compound, a borate compound, an azinium compound, a metallocene compound, an active ester compound, a compound having a carbon halogen bond, and an azo-based compound. Among them, from the viewpoint of engraving sensitivity and good relief edge shape of a crosslinked relief-forming layer, an organic peroxide and an azo-based compound are preferable, and an organic peroxide is particularly preferable.

Furthermore, with regard to preferred examples of components used in combination with the polymerization initiator (D), a combination of an organic peroxide and a photothermal conversion agent is preferable since the engraving sensitivity becomes very high, and a combination of an organic peroxide and carbon black, which is a photothermal conversion agent, is particularly preferable.

This is presumed as follows. When the relief-forming layer is cured by thermal crosslinking using an organic peroxide, an organic peroxide that did not play a part in radical generation and has not reacted remains, and the remaining organic peroxide works as an autoreactive additive and decomposes exothermally in laser engraving. As the result, energy of generated heat is added to the radiated laser energy to thus raise the engraving sensitivity.

It is described in detail in the explanation of a light-heat converting agent, the effect thereof is remarkable when carbon black is used as the light-heat converting agent. It is considered that the heat generated from the carbon black is also transmitted to an organic peroxide and, as the result, heat is generated not only from the carbon black but also from the organic peroxide, and that the generation of heat energy to be used for the decomposition of Component B etc. occurs synergistically.

It is preferable for organic peroxide to have a 10-hour half-life temperature of at least 60° C., more preferably at least 80° C., and particularly preferably at least 100° C. Furthermore, it is preferable for it to have a 10-hour half-life temperature of no greater than 220° C., more preferably no greater than 200° C., and particularly preferably no greater than 180° C.

It is preferable for the 10-hour half-life temperature to be in the above-mentioned range since the resin composition has excellent stability and sufficient crosslink density is obtained.

The 10-hour half-life temperature is measured as follows.

### —Method for Determining 10-Hour Half-Life Temperature—

A 0.1 mol/L concentration solution of a peroxide is prepared using benzene as a solvent, and sealed in a nitrogen-flushed glass tube. This is immersed in a thermostatted bath set at a predetermined temperature, thus carrying out thermal decomposition. Since, in general, decomposition of an organic peroxide in dilute solution can be treated as an approximately first order reaction, when the amount of peroxide decomposed is x (mol/L), the decomposition rate constant is k (1/h), the time is t (h), and the initial peroxide concentration is a (mol/L), Formula (1) and Formula (2) below hold.

dx/dt=k(a−x) (1)

In{a/(a−x)}=kt (2)

Since the half-life is the time taken for the peroxide concentration to decrease to half of the initial value by decomposition, if the half-life is denoted by t_{1/2} and x of Formula (2) is substituted by a/2, this gives Formula (3) below.

kt_{1/2}=In2 (3)

Therefore, the half-life (t_{1/2}) at a given temperature can be determined from Formula (3) by carrying out thermal decomposition at the given temperature, plotting the relationship between time (t) and In{a/(a−x)}, and determining k from the slope of the straight line thus obtained.

With regard to the decomposition rate constant k, when the frequency factor is A (1/h), the activation energy is E (J/mol), the gas constant is R (8.314 J/mol·K), and the absolute temperature is T (K), Formula (4) below holds.

Ink=InA−ΔE/RT (4)

Eliminating k from Formula (3) and Formula (4) gives

In(t_{1/2})=ΔE/RT−In(A/2) (5),

t_{1/2} is calculated for several temperature points, the relationship between In(t_{1/2}) and 1/T is plotted, and the temperature at t_{1/2}=10 hours is determined from the straight line thus obtained.

Organic peroxide is preferably an organic peroxide. The organic peroxide is preferably a dialkyl peroxide, a peroxyketal, a peroxyester, a diacyl peroxide, an alkyl hydroperoxide, a peroxydicarbonate, or a ketone peroxide, and more preferably an organic peroxide selected from the group consisting of a dialkyl peroxide, a peroxyketal, and a peroxyester.

Examples of the dialkyl peroxide include di-t-butyl peroxide, di-t-hexyl peroxide, t-butylcumyl peroxide, dicumyl peroxide, α,α′-bis(t-butylperoxy)diisopropylbenzene, 2,5-dimethyl-2,5-bis(t-butylperoxy)hexane, and 2,5-dimethyl-2,5-bis(t-butylperoxy)hexyne-3.

Examples of the peroxyketal include n-butyl 4,4-bis(t-butylperoxy)valerate, 2,2-bis(t-butylperoxy)butane, 1,1-bis(t-butylperoxy)cyclohexane, 1,1-bis(t-hexylperoxy)cyclohexane, 1,1-bis(t-butylperoxy)-3,3,5-trimethylcyclohexane, and 1,1-bis(t-hexylperoxy)-3,3,5-trimethylcyclohexane.

Examples of the peroxyester include α-cumyl peroxyneodecanoate, 1,1-dimethyl-3-hydroxybutyl peroxy-2-ethylhexanoate, t-amyl peroxybenzoate, t-butyl peroxybenzoate, and t-butyl peroxypivalate.

Furthermore, as the organic peroxide, a diacyl peroxide such as dibenzoyl peroxide, succinic acid peroxide, dilauroyl peroxide, or didecanoyl peroxide, an alkyl hydroperoxide such as 2,5-dihydroperoxy-2,5-dimethylhexane, cumene hydroperoxide, or t-butyl hydroperoxide, or a peroxydicarbonate such as di(n-propyl)peroxydicarbonate, di(sec-butyl)peroxydicarbonate, or di(2-ethylhexyl)peroxydicarbonate may also be used.

Organic peroxides are commercially available from, for example, NOF Corporation, Kayaku Akzo Corporation, etc.

With regard to the polymerization initiator (D) in the present invention, one type may be used on its own or two or more types may be used in combination.

The content of the polymerization initiator (D) in the resin composition for forming crosslinked relief-forming layer is preferably 0.01 to 10 wt % relative to the total weight of the solids content of the resin composition for laser engraving, and more preferably 0.1 to 3 wt %. When the content of the polymerization initiator is at least 0.01 wt %, an effect from the addition thereof is obtained, and crosslinking of a crosslinked relief-forming layer proceeds promptly. Furthermore, when the content is no greater than 10 wt %, other components do not become insufficient, and printing durability that is satisfactory as a relief printing plate is obtained.

The crosslinking agent (B) is now explained.

The crosslinking agent (B) is a compound that crosslinks by a step-growth reaction. The crosslinking agent (B) comprises an addition polymerizable or condensation polymerizable component, and a condensation polymerizable component is preferable.

The crosslinking agent (B) that crosslinks in a step-growth reaction is preferably selected from the group consisting of a polyfunctional isocyanate (B1) containing at least two isocyanate groups, a polyfunctional acid anhydride (B2) containing at least two dibasic acid anhydride residues, and a hydrolyzable silyl group- or silanol group-containing compound (B3) containing at least two alkoxysilyl groups.

The above-mentioned B1, B2, and B3 are explained in detail in sequence below.

### <Compound (B1) Containing at Least Two Isocyanate Groups Per Molecule (Also Called a ‘Polyfunctional Isocyanate’)>

The Resin Composition Used in the Present Invention May Comprise as the crosslinking agent (B) a compound containing at least two isocyanate groups per molecule (polyfunctional isocyanate compound (B1)).

The number of isocyanate groups per molecule of the polyfunctional isocyanate compound (B1) used in the present invention is at least two, and from the viewpoint of forming a three-dimensional crosslinked structure it is preferably 2 to 10, more preferably 2 to 6, and particularly preferably 2 to 4.

The polyfunctional isocyanate compound is explained below.

Examples of the compound containing two isocyanate groups per molecule include m-phenylene diisocyanate, p-phenylene diisocyanate, 2,6-tolylene diisocyanate, 2,4-tolylene diisocyanate, naphthalene-1,4-diisocyanate, diphenylmethane-4,4′-diisocyanate, 3,3′-dimethoxybiphenyl diisocyanate, 3,3′-dimethyldiphenylmethane-4,4′-diisocyanate, xylylene-1,4-diisocyanate, xylylene-1,3-diisocyanate, 4-chloroxylylene-1,3-diisocyanate, 2-methylxylylene-1,3-diisocyanate, 4,4′-diphenylpropane diisocyanate, 4,4′-diphenylhexafluoropropane diisocyanate, trimethylene diisocyanate, hexamethylene diisocyanate, propylene-1,2-diisocyanate, butylene-1,2-diisocyanate, cyclohexylene-1,2-diisocyanate, cyclohexylene-1,3-diisocyanate, cyclohexylene-1,4-diisocyanate, dicyclohexylmethane-4,4′-diisocyanate, 1,4-bis(isocyanatomethyl)cyclohexane, 1,3-bis(isocyanatomethyl)cyclohexane, isophorone diisocyanate, and lysine diisocyanate. Furthermore, addition reaction products of these difunctional isocyanate compounds with a difunctional alcohol such as an ethylene glycol or a bisphenol, or a phenol may also be used.

Yet another polyfunctional isocyanate compound may also be used. Examples of such a compound include a trimer (biuret or isocyanurate) formed using the above-mentioned difunctional isocyanate compound as a main starting material, a polyfunctional product formed as an adduct of the difunctional isocyanate compound with a polyol such as trimethylolpropane, a benzene isocyanate/formalin condensation product, a polymer of an isocyanate compound containing a polymerizable group such as methacryloyloxyethyl isocyanate, and lysine triisocyanate.

It is particularly preferable to use a trimer (biuret or isocyanurate) formed using xylene diisocyanate or a hydrogenated product thereof, hexamethylene diisocyanate, or tolylene diisocyanate or a hydrogenated product thereof as a main starting material or a polyfunctional product formed as an adduct thereof with trimethylolpropane. These compounds are described in ‘Polyurethane Resin Handbook’ (Ed. by K Iwata, Published by The Nikkan Kogyo Shimbun, Ltd. (1987)).

Among the above, 2,4-tolylene diisocyanate, 2,6-tolylene diisocyanate, xylylene-1,4-diisocyanate, xylylene-1,3-diisocyanate, and an adduct between trimethylolpropane and xylylene-1,4-diisocyanate or xylylene-1,3-diisocyanate are preferable, and xylylene-1,4-diisocyanate, xylylene-1,3-diisocyanate, and an adduct between trimethylolpropane and xylylene-1,4-diisocyanate or xylylene-1,3-diisocyanate are particularly preferable.

From the viewpoint of engraving sensitivity, the polyfunctional isocyanate compound (B1) preferably has a heteroatom such as nitrogen, oxygen, or sulfur in a linking part where two isocyanate groups are linked, and more preferably has a carbon-sulfur bond.

More specifically, it is preferable that the linking group having a carbon-sulfur bond is preferably at least one unit (atomic group) selected from —CH₂—S—, —CH₂—SS—, —NHC(═S)O—, —NH(C═O)S—, —NH(C═S)S—, and —CH₂—SO₂—; from the viewpoint of enhancing engraving sensitivity, —CH₂—SS—, —NH(C═S)O—, —NH(C═O)S—, and —NH(C═S)S— are preferable, and —CH₂—SS— and —NH(C═O)S— are most preferable.

The polyfunctional isocyanate compound (B1) preferably has a carbon-sulfur bond at a site where two isocyanate groups are linked; the number of sulfur atoms contained in the molecule is not particularly limited as long as it is at least one and may be selected as appropriate according to the intended purpose, and from the viewpoint of a balance being achieved between engraving sensitivity and solubility in a coating solvent it is preferably 1 to 10, more preferably 1 to 5, and particularly preferably 1 or 2.

Such a sulfur-containing isocyanate containing a sulfur atom in the molecule may be synthesized by an addition reaction of a polyfunctional isocyanate with a sulfur-containing polyfunctional alcohol, a sulfur-containing polyfunctional amine, or a polyfunctional thiol.

Specific examples of the polyfunctional isocyanate compound (B1) are shown below, but the present invention is not limited thereto.

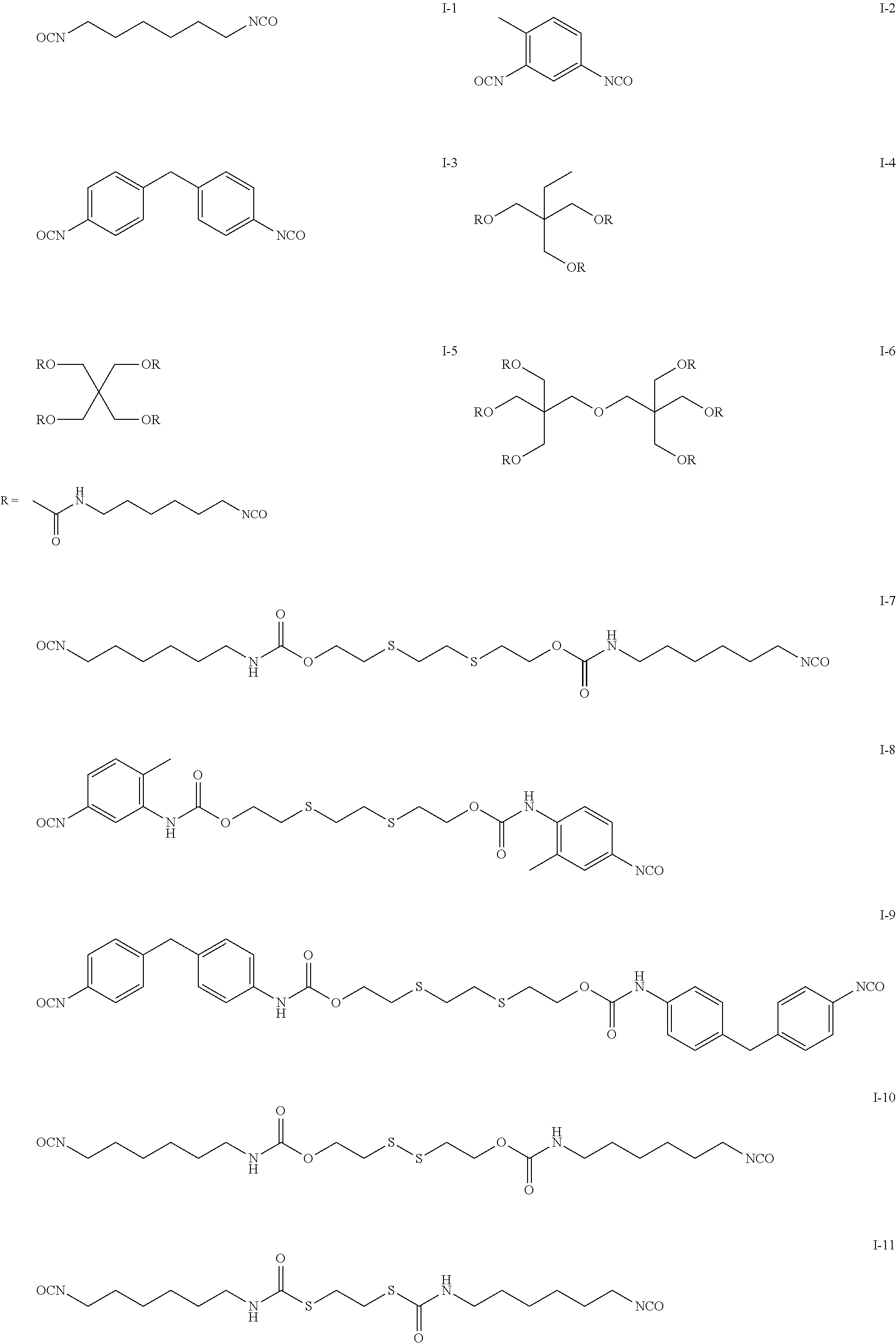

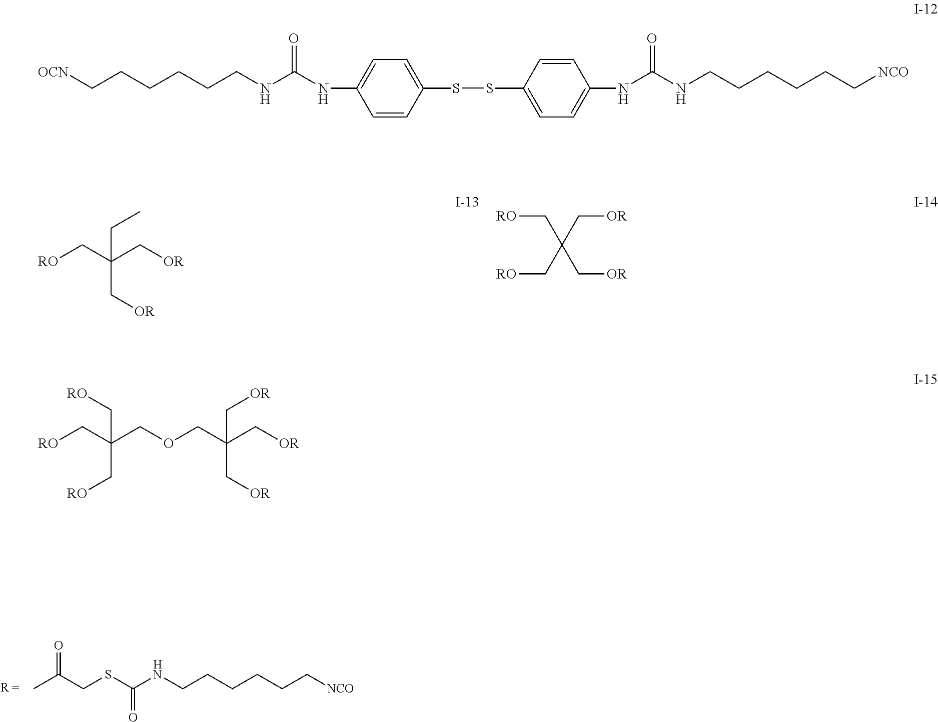

Among the above specific examples of the polyfunctional isocyanate compound (B1), from the viewpoint of improving engraving sensitivity Compound I-7 to Compound I-15 are preferable, Compounds I-7, I-8, I-10, I-11, I-12, and I-13 are more preferable, and Compounds I-7, I-10, and I-11 are particularly preferable.

From the viewpoint of flexibility of a crosslinked relief-forming layer that is formed, the molecular weight of the polyfunctional isocyanate compound (B1) is preferably 100 to 5,000, and more preferably 150 to 3,000.

The amount of polyfunctional isocyanate compound (B1) added is preferably in the range of 0.1 mass % to 80 mass % in the total solids content of the resin composition for forming a relief layer, more preferably 1 mass % to 40 mass %, and yet more preferably 5 mass % to 30 mass %.

### <Compound Containing at Least Two Dibasic Acid Anhydride Residues (B2)>

As a crosslinking agent for the crosslinked relief-forming layer, a compound containing at least two dibasic acid anhydride structures per molecule (B2) (also called a ‘polyfunctional acid anhydride (B2)’) may be used.

Any polyfunctional acid anhydride (B2) may be used as long as it is a compound containing at least two acid anhydride structures, such as carboxylic acid anhydride residues, per molecule. That is, a compound having at least two of said chemical structures per molecule forms a good crosslinked structure with a reactive functional group of a crosslinkable polymer (C), which is described later.

The dibasic acid anhydride structure in the polyfunctional acid anhydride (B2) means an anhydride structure formed by dehydration-condensation of two carboxylic acids present in the same molecule.

From the viewpoint of rinsing properties, the number of carboxylic acid anhydride structures present in the molecule is preferably at least two but no greater than four, more preferably at least two but no greater than three, and most preferably two.

As the component having two acid anhydride residues used in the present invention, a tetrabasic acid dianhydride can be cited preferably.

Specific examples of the tetrabasic acid dianhydride include an aliphatic or aromatic tetracarboxylic acid dianhydride such as biphenyltetracarboxylic acid dianhydride, naphthalenetetracarboxylic acid dianhydride, diphenyl ether tetracarboxylic acid dianhydride, butanetetracarboxylic acid dianhydride, cyclopentanetetracarboxylic acid dianhydride, pyromellitic dianhydride, benzophenonetetracarboxylic acid dianhydride, or pyridinetetracarboxylic acid dianhydride. Furthermore, as a compound having three carboxylic acid anhydride structures, mellitic acid trianhydride, etc. can be cited.

The molecular weight of the polyfunctional acid anhydride (B2) is preferably at least 80 and less than 500.

Specific examples A-1 to A-7 of the polyfunctional acid anhydride (B2) are given below, but the present invention should not be construed as being limited thereto.

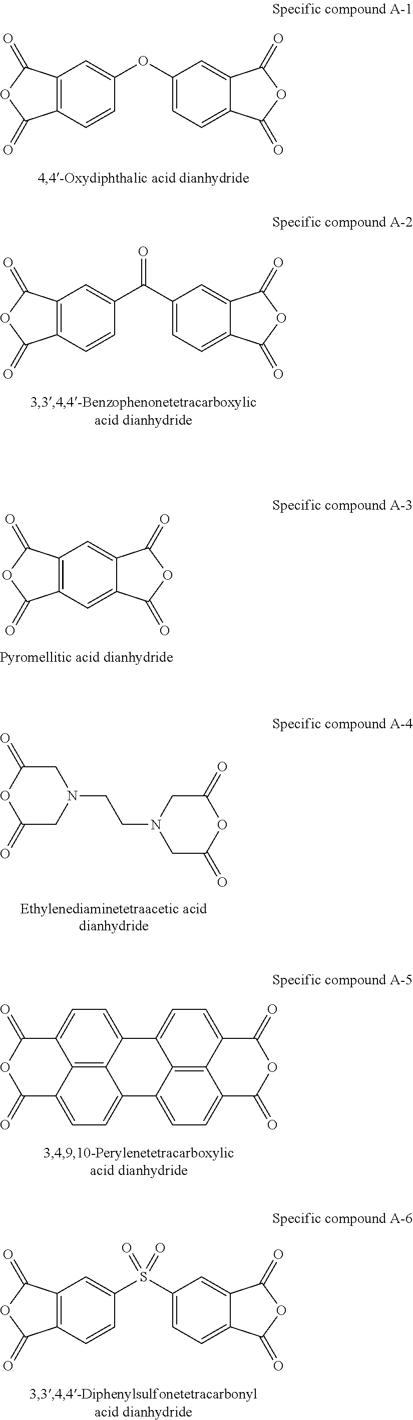 [SMILES: O=C1OC(=O)c2cc(Oc3ccc4c(c3)C(=O)OC4=O)ccc21 ; O=C(c1ccc2c(c1)C(=O)OC2=O)c1ccc2c(c1)C(=O)OC2=O ; O=c1oc(=O)c2cc3c(=O)oc(=O)c3cc12 ; O=C1CN(CCN2CC(=O)OC(=O)C2)CC(=O)O1 ; O=C1OC(=O)c2ccc3c4ccc5c6c(ccc(c7ccc1c2c73)c64)C(=O)OC5=O ; O=C1OC(=O)c2cc(S(=O)(=O)c3ccc4c(c3)C(=O)OC4=O)ccc21]

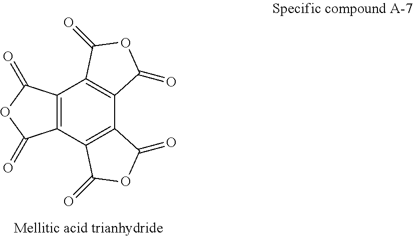 [SMILES: O=c1oc(=O)c2c1c1c(=O)oc(=O)c1c1c(=O)oc(=O)c21]

In the present invention, with regard to the polyfunctional acid anhydride (B2), only one type thereof may be used or two or more types thereof may be used in combination.

The content of the polyfunctional acid anhydride (B2) in the resin composition for a relief-forming layer in order to form a crosslinked relief-forming layer is preferably in the range of 1 to 30 mass % on a solids content basis, more preferably 3 to 30 mass %, and particularly preferably 5 to 30 mass %.

<Hydrolyzable Silyl Group- and/or Silanol Group-Containing Compound, Preferably Polyalkoxysilyl Compound Containing at Least Two Alkoxysilyl Groups (B3)>

The ‘hydrolyzable silyl group’ of the hydrolyzable silyl group- and/or silanol group-containing compound (B3) (also called ‘component B3’) contained in the resin composition for a relief-forming layer of the present invention is a silyl group that can be hydrolyzed, and examples of the hydrolyzable group include an alkoxy group, a mercapto group, a halogen atom, an amide group, an acetoxy group, an amino group, and an isopropenoxy group. A silyl group undergoes hydrolysis to become a silanol group, and a silanol group undergoes dehydration-condensation to form a siloxane bond. Such a hydrolyzable silyl group or silanol group-containing compound (hereinafter, also called an ‘alkoxysilyl compound’) is preferably a compound containing a residue represented by Formula (1) below.

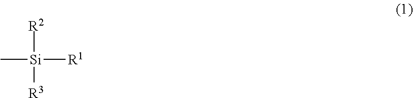

In Formula (1) above, at least one of R¹ to R³ denotes a hydrolyzable group selected from the group consisting of an alkoxy group, a mercapto group, a halogen atom, an amide group, an acetoxy group, an amino group, and an isopropenoxy group, or a hydroxy group. The remainder of R¹ to R³ independently denote a hydrogen atom, a halogen atom, or a monovalent organic substituent (examples including an alkyl group, an aryl group, an alkenyl group, an alkynyl group, and an aralkyl group).

In Formula (1) above, the hydrolyzable group bonded to the silicon atom is particularly preferably an alkoxy group or a halogen atom, and more preferably an alkoxy group.

From the viewpoint of rinsing properties and printing durability, the alkoxy group is preferably an alkoxy group having 1 to 30 carbon atoms, more preferably an alkoxy group having 1 to 15 carbon atoms, yet more preferably an alkoxy group having 1 to 5 carbon atoms, particularly preferably an alkoxy group having 1 to 3 carbon atoms, and most preferably a methoxy group or an ethoxy group.

Furthermore, examples of the halogen atom include an F atom, a Cl atom, a Br atom, and an I atom, and from the viewpoint of ease of synthesis and stability it is preferably a Cl atom or a Br atom, and more preferably a Cl atom.

Component B3 in the present invention is preferably a compound having one or more moieties represented by Formula (1) above, and more preferably a compound having two or more. A polyalkoxysilyl compound having two or more hydrolyzable silyl groups is particularly preferably used. That is, a compound having in the molecule two or more silicon atoms having a hydrolyzable group bonded thereto is preferably used. The number of silicon atoms having a hydrolyzable group bond thereto contained in Component A is preferably at least 2 but no greater than 6, and most preferably 2 or 3.

A range of 1 to 4 of the hydrolyzable groups may bond to one silicon atom, and the total number of hydrolyzable groups in Formula (1) is preferably in a range of 2 or 3. It is particularly preferable that three hydrolyzable groups are bonded to a silicon atom. When two or more hydrolyzable groups are bonded to a silicon atom, they may be identical to or different from each other.

Specific preferred examples of the alkoxy group include a methoxy group, an ethoxy group, a propoxy group, an isopropoxy group, a butoxy group, a tert-butoxy group, a phenoxy group, and a benzyloxy group. A plurality of each of these alkoxy groups may be used in combination, or a plurality of different alkoxy groups may be used in combination.

Examples of the alkoxysilyl group having an alkoxy group bonded thereto include a trialkoxysilyl group such as a trimethoxysilyl group, a triethoxysilyl group, a triisopropoxysilyl group, or a triphenoxysilyl group; a dialkoxymonoalkylsilyl group such as a dimethoxymethylsilyl group or a diethoxymethylsilyl group; and a monoalkoxydialkylsilyl group such as a methoxydimethylsilyl group or an ethoxydimethylsilyl group.

Component A preferably has at least a sulfur atom, an ester bond, a urethane bond, an ether bond, a urea bond, or an imino group.

Among them, from the viewpoint of crosslinkability, Component B3 preferably comprises a sulfur atom, and from the viewpoint of removability (rinsing properties) of engraving residue it is preferable for it to comprise an ester bond, a urethane bond, or an ether bond (in particular, an ether bond contained in an oxyalkylene group), which is easily decomposed by aqueous alkali. Component B3 containing a sulfur atom functions as a vulcanizing agent or a vulcanization accelerator promotes a reaction (crosslinking) of a conjugated diene monomer unit-containing polymer as a crosslinkable polymer (C). As a result, the rubber elasticity necessary as a flexographic printing plate is exhibited. Furthermore, the strength of a crosslinked relief-forming layer and a relief layer is improved.

Furthermore, Component B3 in the present invention is preferably a compound that does not have an ethylenically unsaturated bond.

As Component B3 in the present invention, there can be cited a compound in which a plurality of groups represented by Formula (1) above are bonded via a divalent linking group, and from the viewpoint of the effect, such a divalent linking group is preferably a linking group having a sulfide group (—S—), an imino group (—N(R)—) or a urethane bond (—OCON(R)— or —N(R)COO—). R denotes a hydrogen atom or a substituent. Examples of the substituent denoted by R include an alkyl group, an aryl group, an alkenyl group, an alkynyl group, and an aralkyl group. Lower alkyl group having 1 to 4 carbon atoms is preferable.

A method for synthesizing Component B3 is not particularly limited, and synthesis can be carried out by a known method. As one example, a representative synthetic method for a Component B3 containing a linking group having the above-mentioned specific structure is shown below.

<Synthetic Method for Compound Having Sulfide Group as Linking Group and Having Hydrolyzable Silyl Group and/or Silanol Group>

A synthetic method for a Component A having a sulfide group as a linking group (hereinafter, called as appropriate a ‘sulfide linking group-containing alkoxysilyl Component B3’) is not particularly limited, but specific examples thereof include reaction of a Component B3 having a halogenated hydrocarbon group with an alkali metal sulfide, reaction of a Component B3 having a mercapto group with a halogenated hydrocarbon, reaction of a Component B3 having a mercapto group with a Component B3 having a halogenated hydrocarbon group, reaction of a Component B3 having a halogenated hydrocarbon group with a mercaptan, reaction of a Component B3 having an ethylenically unsaturated double bond with a mercaptan, reaction of a Component B3 having an ethylenically unsaturated double bond with a Component B3 having a mercapto group, reaction of a compound having an ethylenically unsaturated double bond with a Component B3 having a mercapto group, reaction of a ketone with a Component B3 having a mercapto group, reaction of a diazonium salt with a Component B3 having a mercapto group, reaction of a Component B3 having a mercapto group with an oxirane, reaction of a Component B3 having a mercapto group with a Component B3 having an oxirane group, reaction of a mercaptan with a Component B3 having an oxirane group, and reaction of a Component B3 having a mercapto group with an aziridine.

### <Synthetic Method for Alkoxysilyl Compound (B3) Having Imino Group as Linking Group>

A synthetic method for a alkoxysilyl compound B3 having an imino group as a linking group (hereinafter, called as appropriate an ‘imino linking group-containing alkoxysilyl compound B3’) is not particularly limited, but specific examples include reaction of an alkoxysilyl compound B3 having an amino group with a halogenated hydrocarbon, reaction of an alkoxysilyl compound B3 having an amino group with an alkoxysilyl compound B3 having a halogenated hydrocarbon group, reaction of an alkoxysilyl compound B3 having a halogenated hydrocarbon group with an amine, reaction of an alkoxysilyl compound B3 having an amino group with an oxirane, reaction of an alkoxysilyl compound B3 having an amino group with an alkoxysilyl compound B3 having an oxirane group, reaction of an amine with an alkoxysilyl compound B3 having an oxirane group, reaction of an alkoxysilyl compound B3 having an amino group with an aziridine, reaction of an alkoxysilyl compound B3 having an ethylenically unsaturated double bond with an amine, reaction of an alkoxysilyl compound B3 having an ethylenically unsaturated bond with an alkoxysilyl compound B3 having an amino group, reaction of a compound having an ethylenically unsaturated bond with an alkoxysilyl compound B3 having an amino group, reaction of a compound having an acetylenically unsaturated triple bond with an alkoxysilyl compound B3 having an amino group, reaction of an alkoxysilyl compound B3 having an imine-based unsaturated double bond with an organic alkali metal compound, reaction of an alkoxysilyl compound B3 having an imine-based unsaturated bond with an organic alkaline earth metal compound, and reaction of a carbonyl compound with an alkoxysilyl compound B3 having an amino group.

### <Synthetic Method for Alkoxysilyl Compound B3 Having Urethane Bond (Ureylene Group) as Linking Group>

A synthetic method for alkoxysilyl compound B3 having an ureylene group (hereinafter, called as appropriate a ‘ureylene linking group-containing an alkoxysilyl compound B3’) as a linking group is not particularly limited, but specific examples include synthetic methods such as reaction of an alkoxysilyl compound B3 having an amino group with an isocyanate ester, reaction of an alkoxysilyl component B3 having an amino group with an alkoxysilyl compound B3 having an isocyanate ester, and reaction of an amine with an alkoxysilyl component B3 having an isocyanate ester.

Alkoxysilyl compound B3 is preferably a compound represented by Formula (A-1) or Formula (A-2) below.

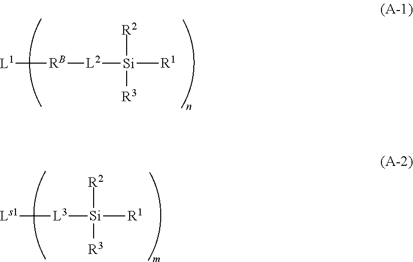

(In Formula (A-1) and Formula (A-2), R^{B} denotes an ester bond, an amide bond, a urethane bond, a urea bond, or an imino group, L¹ denotes an n-valent linking group, L² denotes a divalent linking group, L^{s1} denotes an co-valent linking group, L³ denotes a divalent linking group, n and m independently denote an integer of 1 or greater, and R¹ to R³ independently denote a hydrogen atom, a halogen atom, or a monovalent organic substituent. In addition, at least one of R¹ to R³ denotes a hydrolyzable group selected from the group consisting of an alkoxy group, a mercapto group, a halogen atom, an amide group, an acetoxy group, an amino group, and an isopropenoxy group, or a hydroxy group.)

R¹ to R³ in Formula (A-1) and Formula (A-2) above have the same meanings as those of R¹ to R³ in Formula (1) above, and preferred ranges are also the same.

From the viewpoint of rinsing properties and film strength, R^{B} above is preferably an ester bond or a urethane bond, and is more preferably an ester bond.

The divalent or n-valent linking group denoted by L¹ to L³ above is preferably a group formed from at least one type of atom selected from the group consisting of a carbon atom, a hydrogen atom, an oxygen atom, a nitrogen atom, and a sulfur atom, and is more preferably a group formed from at least one type of atom selected from the group consisting of a carbon atom, a hydrogen atom, an oxygen atom, and a sulfur atom. The number of carbon atoms of L¹ to L³ above is preferably 2 to 60, and more preferably 2 to 30.

The m-valent linking group denoted by L^{s1} above is preferably a group formed from a sulfur atom and at least one type of atom selected from the group consisting of a carbon atom, a hydrogen atom, an oxygen atom, a nitrogen atom, and a sulfur atom, and is more preferably an alkylene group or a group formed by combining two or more from an alkylene group, a sulfide group, and an imino group. The number of carbon atoms of L^{s1} above is preferably 2 to 60, and more preferably 6 to 30.

n and m above are independently integers of 1 to 10, more preferably integers of 2 to 10, yet more preferably integers of 2 to 6, and particularly preferably 2.

From the viewpoint of removability (rinsing properties) of engraving residue, the n-valent linking group denoted by L¹ and/or the divalent linking

group denoted by L², or the divalent linking group denoted by L³ preferably has an ether bond, and more preferably has an ether bond contained in an oxyalkylene group.

Among compounds represented by Formula (A-1) or Formula (A-2), from the viewpoint of crosslinkability, etc., the n-valent linking group denoted by L¹ and/or the divalent linking group denoted by L² in Formula (A-1) are preferably groups having a sulfur atom.

Specific examples of alkoxysilyl compound B3 that can be applied to the present invention are shown below. Examples thereof include vinyltrichlorosilane, 1,3-bis(trichlorosilane)propane, 1,3-bis(tribromosilane)propane, vinyltrimethoxysilane, vinyltriethoxysilane, β-(3,4-epoxycyclohexyl)ethyltrimethoxysilane, γ-glycidoxypropyltrimethoxysilane, γ-glycidoxypropylmethyldiethoxysilane, γ-glycidoxypropyltriethoxysilane, γ-methacryloxypropylmethyldimethoxysilane, p-styryltrimethoxysilane, γ-methacryloxypropyltrimethoxysilane, γ-methacryloxypropylmethyldiethoxysilane, γ-methacryloxypropyltriethoxysilane, γ-acryloxypropyltrimethoxysilane, N-(β-aminoethyl)-γ-aminopropylmethyldimethoxysilane, N-(β-aminoethyl)-γ-aminopropyltrimethoxysilane, N-(β-aminoethyl)-γ-aminopropyltriethoxysilane, γ-aminopropyltrimethoxysilane, γ-aminopropyltriethoxysilane, N-phenyl-γ-aminopropyltrimethoxysilane, γ-mercaptopropyltrimethoxysilane, γ-mercaptopropyltriethoxysilane, mercaptomethyltrimethoxysilane, dimethoxy-3-mercaptopropylmethylsilane, 2-(2-aminoethylthioethyl)diethoxymethylsilane, 3-(2-acetoxyethylthiopropyl)dimethoxymethylsilane, 2-(2-aminoethylthioethyl)triethoxysilane, dimethoxymethyl-3-(3-phenoxypropylthiopropyl)silane, bis(triethoxysilylpropyl)disulfide, bis(triethoxysilylpropyl)tetrasulfide, 1,4-bis(triethoxysilyl)benzene, bis(triethoxysilyl)ethane, 1,6-bis(trimethoxysilyl)hexane, 1,8-bis(triethoxysilyl)octane, 1,2-bis(trimethoxysilyl)decane, bis(triethoxysilylpropyl)amine, bis(trimethoxysilylpropyl)urea, γ-chloropropyltrimethoxysilane, γ-triethoxysilylpropyl(meth)acrylate, γ-ureidopropyltriethoxysilane, trimethylsilanol, diphenylsilanediol, and triphenylsilanol. Other than the above, the compounds shown below can be cited as preferred examples, but the present invention should not be construed as being limited thereto.

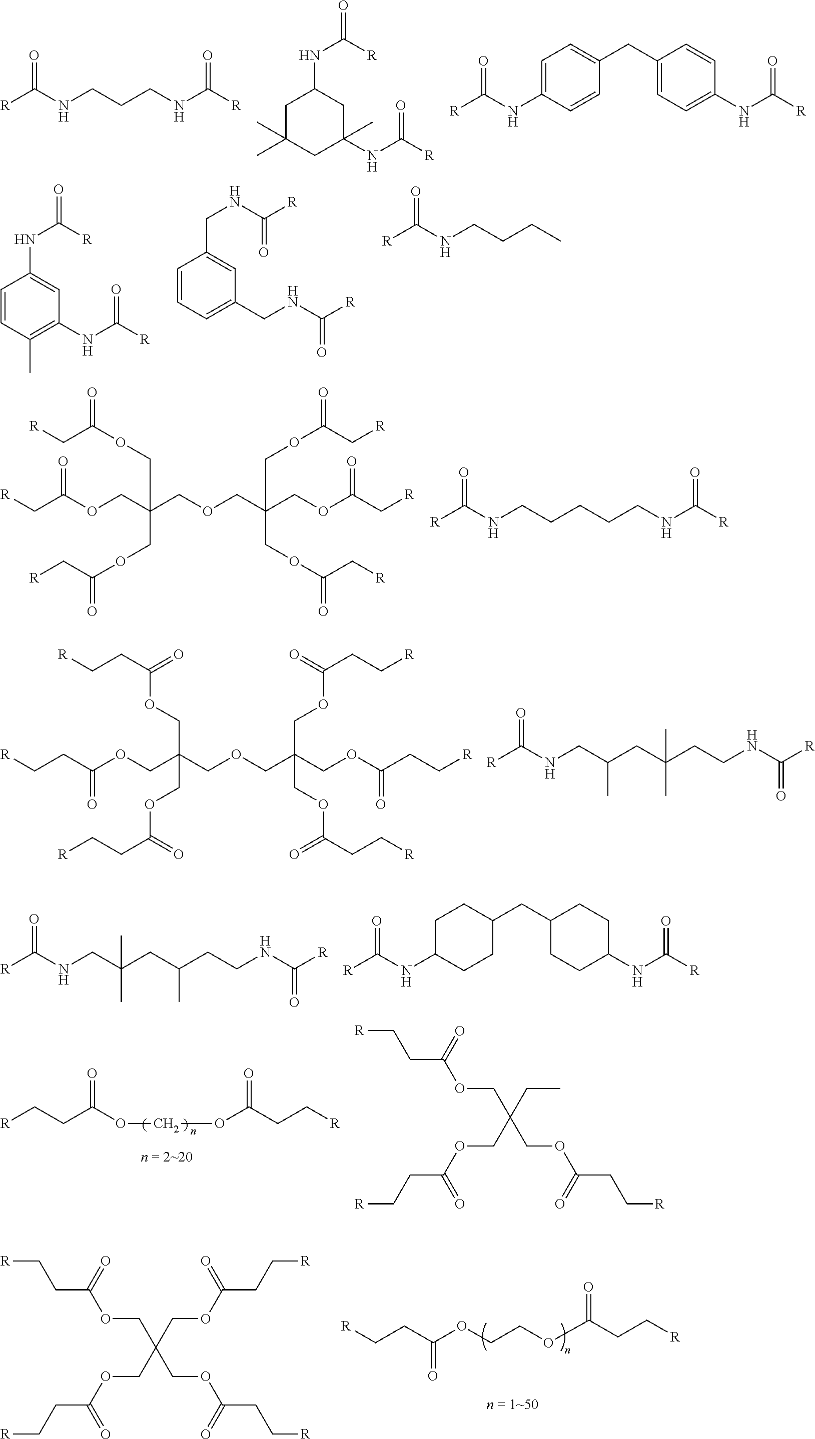

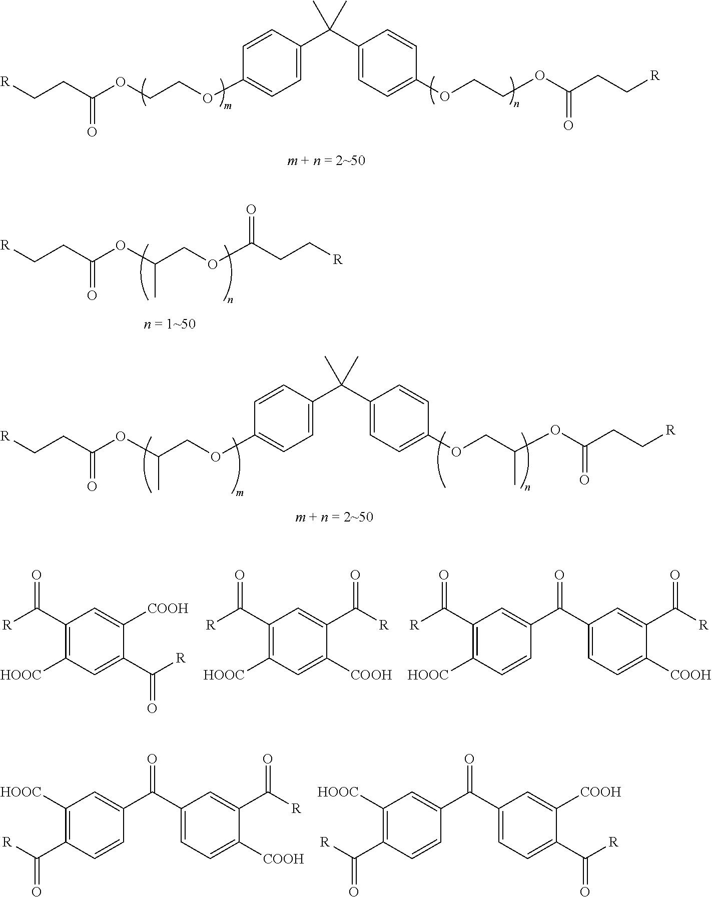

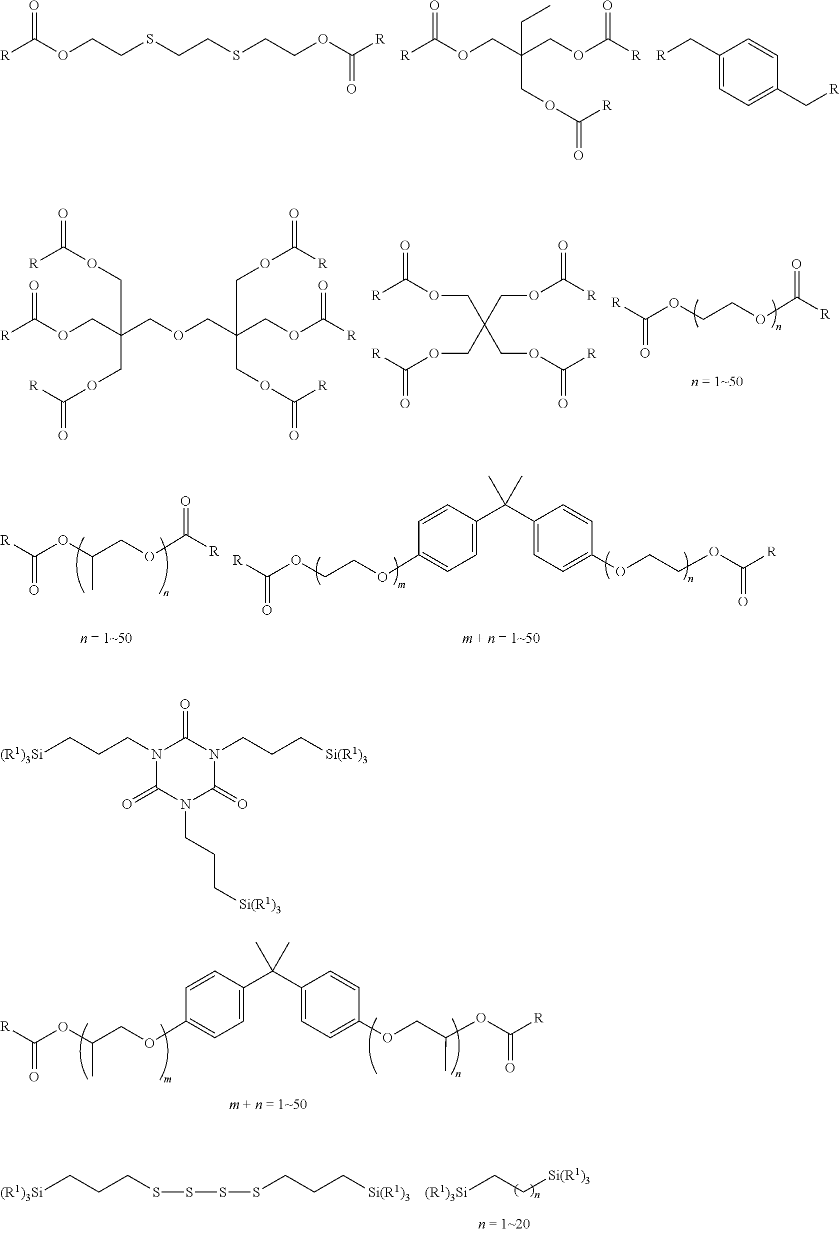

In each of the formulae above, R denotes a partial structure selected from the structures below. When a plurality of Rs and R¹s are present in the molecule, they may be identical to or different from each other, and are preferably identical to each other in terms of synthetic suitability.

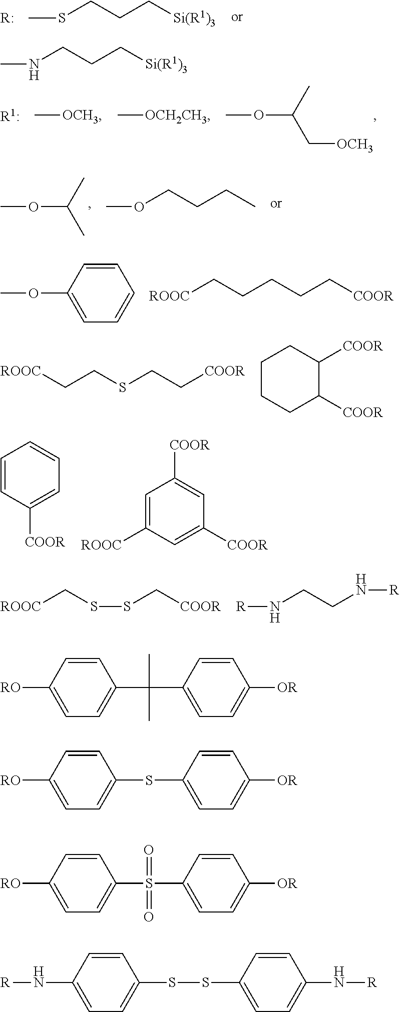

In each of the formulae above, R denotes a partial structure shown below. R¹ is the same as defined above. When a plurality of R⁵ and R¹s are present in the molecule, they may be identical to or different from each other, and in terms of synthetic suitability are preferably identical to each other.

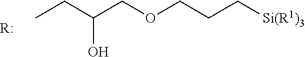

Alkoxysilyl compound B3 may be obtained by synthesis as appropriate, but use of a commercially available product is preferable in terms of cost. Since alkoxysilyl compound B3 corresponds to for example commercially available silane products or silane coupling agents from Shin-Etsu Chemical Co., Ltd., Dow Corning Toray, Momentive Performance Materials Inc., Chisso Corporation, etc., the resin composition of the present invention may employ such a commercially available product by appropriate selection according to the intended application.

As alkoxysilyl compound B3 in the present invention, a partial hydrolysis-condensation product obtained using one type of compound having a hydrolyzable silyl group and/or a silanol group or a partial cohydrolysis-condensation product obtained using two or more types may be used. Hereinafter, these compounds may be called ‘partial (co)hydrolysis-condensation products’.

Among silane compounds as partial (co)hydrolysis-condensation product precursors, from the viewpoint of versatility, cost, and film compatibility, a silane compound having a substituent selected from a methyl group and a phenyl group as a substituent on the silicon is preferable, and specific preferred examples of the precursor include methyltrimethoxysilane, methyltriethoxysilane, phenyltrimethoxysilane, phenyltriethoxysilane, dimethyldimethoxysilane, dimethyldiethoxysilane, diphenyldimethoxysilane, and diphenyldiethoxysilane.

In this case, as a partial (co)hydrolysis-condensation product, it is desirable to use a dimer (2 moles of silane compound is reacted with 1 mole of water to eliminate 2 moles of alcohol, thus giving a disiloxane unit) to 100-mer of the above-mentioned silane compound, preferably a dimer to 50-mer, and yet more preferably a dimer to 30-mer, and it is also possible to use a partial cohydrolysis-condensation product formed using two or more types of silane compounds as starting materials.

As such a partial (co)hydrolysis-condensation product, ones commercially available as silicone alkoxy oligomers may be used (e.g. those from Shin-Etsu Chemical Co., Ltd.) or ones that are produced in accordance with a standard method by reacting a hydrolyzable silane compound with less than an equivalent of hydrolytic water and then removing by-products such as alcohol and hydrochloric acid may be used. When the production employs, for example, an acyloxysilane or an alkoxysilane described above as a hydrolyzable silane compound starting material, which is a precursor, partial hydrolysis-condensation may be carried out using as a reaction catalyst an acid such as hydrochloric acid or sulfuric acid, an alkali metal or alkaline earth metal hydroxide such as sodium hydroxide or potassium hydroxide, or an alkaline organic material such as triethylamine, and when the production is carried out directly from a chlorosilane, water and alcohol may be reacted using hydrochloric acid by-product as a catalyst.

With regard to the alkoxysilyl compound (B3) contained in the resin composition for a relief-forming layer, one type thereof may be used on its own or two or more types thereof may be used in combination.

The content of the alkoxysilyl compound (B3) contained in the resin composition used in the present invention is preferably in the range of 0.1 to 80 mass % on a solids content basis, more preferably 1 to 40 mass %, and particularly preferably 5 to 30 mass %.

From the viewpoint of residue removability (rinsing properties), the alkoxysilyl compound (B3) is preferable as the crosslinking agent (B). That is, the higher the resolution of an image, the more of an issue are the rinsing properties for residue between relief portions after exposure.

In the present invention, when the alkoxysilyl compound (B3) is used as the crosslinking agent (B) that crosslinks in a step-growth reaction, since component B3 has self-crosslinkability, a crosslinkable polymer (C) is not always necessary. Although SI (styrene isoprene block copolymer) in Examples 15 and 16, which are described later, is entered in the ‘Crosslinking polymer’ column, it is not a component that crosslinks with S-1 or S-3, which is component B3. Step-growth crosslinking progresses between components B3. <(Y) Alcohol Exchange Reaction Catalyst>

The resin composition of the present invention preferably comprises (Component Y) an alcohol exchange reaction catalyst in order to promote formation of a crosslinked structure from the crosslinking agent (B). The alcohol exchange reaction catalyst may be used without any restrictions as long as it is a reaction catalyst generally used in a silane coupling reaction. Hereinafter, (Component Y-1) an acidic or basic catalyst and (Component Y-2) a metal complex catalyst, which are representative alcohol exchange reaction catalysts, are explained in sequence.

### (Component Y-1) Acidic or Basic Catalyst

As the catalyst, an acidic or basic compound is used as it is or in the form of a solution in which it is dissolved in a solvent such as water or an organic solvent (hereinafter, also called an acidic catalyst or basic catalyst respectively). The concentration when dissolved in a solvent is not particularly limited, and it may be selected appropriately according to the properties of the acidic or basic compound used, desired catalyst content, etc.

Examples of the acidic catalyst include a hydrogen halide such as hydrochloric acid, nitric acid, sulfuric acid, sulfurous acid, hydrogen sulfide, perchloric acid, hydrogen peroxide, carbonic acid, a carboxylic acid such as formic acid or acetic acid, a carboxylic acid in which R of the structural formula RCOOH is substituted with another element or substituent, a sulfonic acid such as benzenesulfonic acid, phosphoric acid, a heteropoly acid, and an inorganic solid acid.

Examples of the basic catalyst include an ammoniacal base such as aqueous ammonia, an amine, an alkali metal hydroxide, an alkali metal alkoxide, an alkaline earth oxide, a quaternary ammonium salt compound, and a quaternary phosphonium salt compound.

Examples of the amine include (a) a hydrogenated nitrogen compound such as hydrazine; (b) an aliphatic amine, alicyclic amine or aromatic amine; (c) a condensed ring-containing cyclic amine; (d) an oxygen-containing amine such as an amino acid, an amide, an alcoholamine, an ether amine, an imide or a lactam; and (e) a heteroelement-containing amine having a heteroatom such as S or Se.

As the aliphatic amine (b), an amine compound represented by Formula (Y-1) is preferable.

N(R^{d1})(R^{d2})(R^{d3}) (Y-1)

In Formula (Y-1), R^{d1} to R^{d3} independently denote a hydrogen atom, a straight-chain or branched alkyl group having 1 to 10 carbon atoms, a cycloalkyl group having 5 to 10 carbon atoms, an aryl group having 6 to 20 carbon atoms, or a 3- to 10-membered sulfur atom- or oxygen atom-containing heterocycle (a thiophene), and the alkyl group and cycloalkyl group may have at least one unsaturated bond.

The amine compound represented by Formula (Y-1) may have a substituent, and examples of the substituent include an alkyl group having 1 to 10 carbon atoms, an aryl group having 6 to 20 carbon atoms, an amino group, a (di)alkylamino group having an alkyl group having 1 to 6 carbon atoms, and a hydroxy group.

Two or more groups among R^{d1} to R^{d3} above may be bonded to form a C═N bond. Examples of an amine compound having a C═N bond include guanidine and 1,1,3,3-tetramethylguanidine.

Examples of the alicyclic amine (b) include an alicyclic amine in which a ring skeleton, where two or more groups among R^{d1} to R^{d3} in a compound represented by Formula (Y-1) above are bonded, contains a nitrogen atom. Examples of the alicyclic amine include pyrrolidine, piperidine, piperazine, and quinuclidine.

Examples of the aromatic amine (b) include imidazole, pyrrole, pyridine, pyridazine, pyrazine, purine, quinoline, and quinazoline. The aromatic amine may have a substituent, and examples of the substituent include substituents described for Formula (Y-1).

Furthermore, two or more identical or different aliphatic amines, alicyclic amines, or aromatic amines may be bonded to form a polyamine such as a diamine or a triamine. The polyamine is preferably a polyamine in which aliphatic amines are bonded, and examples thereof include hexamethylenetetramine and polyethyleneimine (Epomin, Nippon Shokubai Co., Ltd.). In the present invention, component D is preferably a polyamine, and more preferably a polyethyleneimine.

The cyclic amine (c) containing a condensed ring is a cyclic amine in which at least one nitrogen atom is contained in a ring skeleton forming a condensed ring; examples thereof include 1,8-diazabicyclo[5.4.0]undec-7-ene, 1,5-diazabicyclo[4.3.0]non-5-ene, and 1,4-diazabicyclo[2.2.2]octane, and 1,8-diazabicyclo[5.4.0]undec-7-ene is preferable.

Examples of the oxygen-containing amine (d) such as an amino acid, an amide, an alcoholamine, an ether amine, an imide, or a lactam include phthalimide, 2,5-piperazinedione, maleimide, caprolactam, pyrrolidone, morpholine, glycine, alanine, and phenylalanine.

In addition, (c) and (d) may have the substituent described for a compound represented by Formula (Y-1), and among them an alkyl group having 1 to 6 carbon atoms is preferable.

As the amine compound in the present invention, (b) and (c) are preferable. As (b), an aliphatic amine is preferable, a polyamine of an aliphatic amine is more preferable, and polyethyleneimine is yet more preferable. As (c), 1,8-diazabicyclo[5.4.0]undec-7-ene is preferable.

From the viewpoint of film strength after thermal crosslinking, the amine preferably has a pKa (an acid dissociation constant of the conjugate acid) of at least 7, and more preferably 11-13

Flexographic printing plate of the present invention preferably comprises compound having an acid dissociation constant of the conjugate acid (pKa) of 11-13.

Among the above-mentioned acidic or basic catalysts, from the viewpoint of an alcohol exchange reaction progressing quickly in the film, methanesulfonic acid, p-toluenesulfonic acid, pyridinium p-toluenesulfonate, dodecylbenzenesulfonic acid, phosphoric acid, phosphonic acid, acetic acid, polyethyleneimine, 1,8-diazabicyclo[5.4.0]undec-7-ene, 1,5-diazabicyclo[4.3.0]non-5-ene, and 1,1,3,3-tetramethylguanidine are preferable, and phosphoric acid, polyethyleneimine, and 1,8-diazabicyclo[5.4.0]-7-undecene are particularly preferable.

With regard to the compound having an acid dissociation constant of the conjugate acid (pKa) of 11-13 used in a resin composition of the present invention, one type may be used on its own or two or more types may be used in combination. The content of the above-mentioned basic catalyst in the resin composition is preferably 0.01 to 20 mass % relative to the total solids content of the resin composition, more preferably 1 to 10 mass %, and specifically preferably 0.5 to 5 mass %.

### (Y-2) Metal Complex Catalyst

The metal complex catalyst (Y-2) that can be used as an alcohol exchange reaction catalyst in the present invention is preferably constituted from a metal element selected from Groups 2A, 3A, 4A and 5A of the periodic table and an oxo or hydroxy oxygen compound selected from β-diketones, ketoesters, hydroxycarboxylic acids and esters thereof, amino alcohols, and enolic active hydrogen compounds.

Furthermore, among the constituent metal elements, a Group 2A element such as Mg, Ca, St, or Ba, a Group 3B element such as Al or Ga, a Group 4A element such as Ti or Zr, and a Group 5A element such as V, Nb, or Ta are preferable, and they form a complex having an excellent catalytic effect. Among them, a complex obtained from Zr, Al, or Ti (ethyl orthotitanate, etc.) is excellent and preferable.

In the present invention, examples of the oxo or hydroxy oxygen-containing compound constituting a ligand of the above-mentioned metal complex include β-diketones such as acetylacetone (2,4-pentanedione) and 2,4-heptanedione, ketoesters such as methyl acetoacetate, ethyl acetoacetate, and butyl acetoacetate, hydroxycarboxylic acids and esters thereof such as lactic acid, methyl lactate, salicylic acid, ethyl salicylate, phenyl salicylate, malic acid, tartaric acid, and methyl tartarate, ketoalcohols such as 4-hydroxy-4-methyl-2-pentanone, 4-hydroxy-2-pentanone, 4-hydroxy-4-methyl-2-pentanone, and 4-hydroxy-2-heptanone, amino alcohols such as monoethanolamine, N,N-dimethylethanolamine, N-methylmonoethanolamine, diethanolamine, and triethanolamine, enolic active compounds such as methylolmelamine, methylolurea, methylolacrylamide, and diethyl malonate ester, and compounds having a substituent on the methyl group, methylene group, or carbonyl carbon of acetylacetone (2,4-pentanedione).

A preferred ligand is an acetylacetone derivative, and the acetylacetone derivative in the present invention means a compound having a substituent on the methyl group, methylene group, or carbonyl carbon of acetylacetone. The substituent with which the methyl group of acetylacetone is substituted is a straight-chain or branched alkyl group, acyl group, hydroxyalkyl group, carboxyalkyl group, alkoxy group, or alkoxyalkyl group that all have 1 to 3 carbon atoms, the substituent with which the methylene carbon of acetylacetone is substituted is a carboxy group or a straight-chain or branched carboxyalkyl group or hydroxyalkyl group having 1 to 3 carbon atoms, and the substituent with which the carbonyl carbon of acetylacetone is substituted is an alkyl group having 1 to 3 carbon atoms, and in this case the carbonyl oxygen turns into a hydroxy group by addition of a hydrogen atom.

Specific preferred examples of the acetylacetone derivative include acetylacetone, ethylcarbonylacetone, n-propylcarbonylacetone, i-propylcarbonylacetone, diacetylacetone, 1-acetyl-1-propionylacetylacetone, hydroxyethylcarbonylacetone, hydroxypropylcarbonylacetone, acetoacetic acid, acetopropionic acid, diacetoacetic acid, 3,3-diacetopropionic acid, 4,4-diacetobutyric acid, carboxyethylcarbonylacetone, carboxypropylcarbonylacetone, and diacetone alcohol, and among them acetylacetone and diacetylacetone are preferable. The complex of the acetylacetone derivative and the metal element is a mononuclear complex in which 1 to 4 molecules of acetylacetone derivative coordinate to one metal element, and when the number of coordinatable sites of the metal element is larger than the total number of coordinatable bond sites of the acetylacetone derivative, a ligand that is usually used in a normal complex, such as a water molecule, a halide ion, a nitro group, or an ammonio group may coordinate thereto.

Preferred examples of the metal complex include a tris(acetylacetonato)aluminum aquo complex salt, a di(acetylacetonato)aluminum-aqua complex salt, a mono(acetylacetonato)aluminum-chloro complex salt, a di(diacetylacetonato)aluminum complex salt, ethyl acetoacetate aluminum diisopropylate, aluminum tris(ethyl acetoacetate), cyclic aluminum oxide isopropylate, a tris(acetylacetonato)barium complex salt, a di(acetylacetonato)titanium complex salt, a tris(acetylacetonato)titanium complex salt, a di-i-propoxy-bis(acetylacetonato)titanium complex salt, zirconium tris(ethyl acetoacetate), and a zirconium tris(benzoic acid) complex salt. They are excellent in terms of stability in an aqueous coating solution and an effect in promoting gelling in a sol-gel reaction when thermally drying, and among them ethyl acetoacetate aluminum diisopropylate, aluminum tris(ethyl acetoacetate), a di(acetylacetonato)titanium complex salt, and zirconium tris(ethyl acetoacetate) are particularly preferable.

The resin composition usable in the present invention may employ only one type of alcohol exchange reaction catalyst (Y) or two or more types thereof in combination. The content of alcohol exchange reaction catalyst (Y) in the resin composition is preferably 0.01 to 20 mass % relative to the total solids content of the relief-forming layer, and more preferably 0.1 to 10 mass %.

### <Crosslinkable Polymer (C)>

The resin composition for relief-forming layer contains a crosslinkable polymer (hereinafter, also referred to as “binder polymer” or “binder”).

The binder contained in the resin composition for the above-mentioned relief-forming layer preferably is a non-elastomer. The non-elastomer binder preferably usable in the present invention is explained after a binder which can be used generally in the present invention.

The crosslinkable polymer (C) is a polymer component contained in the resin composition for a relief-forming layer and has a crosslinkable group that reacts with the crosslinking agent (B). In particular, from the viewpoint of the resin composition for a relief-forming layer being used for a printing plate precursor, it is preferable to carry out selection while taking into consideration various performance characteristics such as laser engraving properties, ink laydown/pick-up properties, and engraving residue dispersibility.

The binder can be used as a crosslinkable polymer (C) having a crosslinkable groups which reacts with the crosslinking agent (B), and can be selected from a polystyrene resin, a polyester resin, a polyamide resin, a polyurea resin, a polyamideimide resin, a polyurethane resin, a polysulfone resin, a polyether sulfone resin, a polyimide resin, a polycarbonate resin, a hydrophilic polymer containing a hydroxyethylene unit, an acrylic resin, an acetal resin, an epoxy resin, a polycarbonate resin, a rubber, a thermoplastic elastomer and the like.

The polymer that can be used in combination with the crosslinkable polymer (C) is now explained.

From the viewpoint of for example laser engraving sensitivity, as a polymer that can be used in combination, a polymer containing a partial structure that undergoes thermal decomposition by exposure to light or heat is preferable. Preferred examples of such a polymer include those described in paragraph 0038 of JP-A-2008-163081. Furthermore, for example, for the purpose of forming a film having pliability and flexibility, a flexible resin or a thermoplastic elastomer is selected. They are described in detail in paragraphs 0039 to 0040 of JP-A-2008-163081. Furthermore, when the resin composition for a relief-forming layer is applied to a relief-forming layer of the relief printing plate precursor for laser engraving, from the viewpoint of ease of preparation of the composition for a relief-forming layer and improvement of durability of the obtained relief printing plate toward an oil-based ink, it is preferable to use a hydrophilic or alcoholphilic polymer. As the hydrophilic polymer, those described in detail in paragraph 0041 of JP-A-2008-163081 may be used.

Similarly, when the polymer that can be used in combination is used for the purpose of improving strength by curing by means of exposure to heat or light, a polymer having a carbon-carbon unsaturated bond in the molecule is preferably used.

As such binders, examples of binders comprising a carbon-carbon unsaturated bond in a main chain include SB (polystyrene-polybutadiene), SBS (polystyrene-polybutadiene-polystyrene), SIS (polystyrene-polyisoprene-polystyrene), SEBS (polystyrene-polyethylene/polybutylene-polystyrene), etc.

Polymers having an ethylenically unsaturated bond in a side chain are obtained by introducing a carbon-carbon unsaturated bond such as an allyl group, an acryloyl group, a methacryloyl group, a styryl group, a vinyl ether group or the like into the side chain of the skeleton of a binder polymer described later. As the method for introducing a carbon-carbon unsaturated bond into the side chain of the binder polymer, known methods may be employed, such as (1) a method in which a structural unit having a polymerizable group precursor formed by linking a protective group to a polymerizable group is copolymerized with a polymer, and the protective group is removed to form the polymerizable group, (2) a method in which a polymeric compound having plural reactive groups such as a hydroxyl group, an amino group, an epoxy group, a carboxylic group or the like is produced, and a compound having a group reacting with these reactive groups and a carbon-carbon unsaturated bond is introduced by a polymer reaction, etc. According to these methods, the amount of an unsaturated bond and polymerizable group to be introduced into the polymer compound can be controlled.

The crosslinkable polymer (C) preferably has a glass transition temperature (Tg) of at least 20° C.

From the viewpoint of mechanical properties of a crosslinked relief-forming layer, it is preferable that the crosslinkable polymer (C) has a glass transition temperature (Tg) of at least 20° C. (room temperature). In this case, engraving sensitivity is also improved when combined with (E) a photothermal conversion agent that can absorb light having a wavelength of 700 to 1,300 nm, which is described later. The binder polymer having such a glass transition temperature is called a non-elastomer below. That is, an elastomer is generally a polymer having a glass transition temperature of no greater than room temperature (ref. Kagaku Dai Jiten 2^{nd} edition (Science Dictionary), Foundation for Advancement of International Science, Maruzen, P. 154). Therefore, a non-elastomer is referred to a polymer which has a glass transition temperature of no greater than room temperature.

The upper limit for the glass transition temperature of the crosslinkable polymer (C) is not limited, but is preferably no greater than 200° C. from the viewpoint of ease of handling, more preferably at least 20° C. but no greater than 200° C., and particularly preferably at least 25° C. but no greater than 120° C.

When a polymer having a glass transition temperature of greater than 20° C. (room temperature) is used as a crosslinkable polymer (C), the crosslinkable polymer (C) is in a glass state at normal temperature. Because of this, compared with a case of the rubber state, thermal molecular motion is considerably suppressed. In laser engraving, in addition to the heat given by a laser during laser irradiation, heat generated by the function of a photothermal conversion agent (E) added as desired is transmitted to the surrounding crosslinkable polymer (C), and this polymer is thermally decomposed and disappears, thereby forming an engraved recess.

In a preferred embodiment of the present invention, it is surmised that when a photothermal conversion agent (E) is present in a state in which thermal molecular motion of a crosslinkable polymer (C) is suppressed, heat transfer to and thermal decomposition of the crosslinkable polymer (C) occur effectively. It is anticipated that such an effect further increases the engraving sensitivity.

The weight-average molecular weight (on a polystyrene basis by GPC measurement) of the crosslinkable polymer (C) useful in the present invention is preferably 5,000 to 500,000, more preferably 10,000 to 400,000, and yet more preferably 15,000 to 300,000. When the weight-average molecular weight is at least 5,000, the shape retention as a single resin is excellent, and when it is no greater than 500,000, it is easily dissolved in a solvent such as water and it is convenient for preparation of the resin composition for laser engraving for the relief-forming layer.

In this way, physical properties that are commensurate with the intended application of the resin composition for a relief-forming layer are taken into consideration, a binder polymer is selected according to the purpose, and one type or two or more types in combination of the crosslinkable polymers (C) may be used.

The content of the crosslinkable polymer (C) is preferably 5 mass % to 80 mass % of the total solids content of the resin composition, more preferably 15 mass % to 75 mass %, and particularly preferably 20 mass % to 65 mass %.

For example, when a relief-forming layer is formed by crosslinking the resin composition for a relief-forming layer, by setting the content of the binder polymer to be at least 15 mass %, it is possible to impart sufficient printing durability as a printing plate to the relief printing plate obtained and, furthermore, by setting it to be no greater than 75 mass %, other components do not become insufficient and even when the relief printing plate is used as a flexographic printing plate it is possible to obtain flexibility that is sufficient for use as a printing plate.

<(C1) Polymer Compound Having One or More Groups Selected from Group Consisting of Hydroxy Group and —NHR (Hereinafter, Also Simply Called a ‘Specific Crosslinkable Polymer (C1)’ as Appropriate)>

The crosslinkable polymer (C) is preferably a polyvinyl acetal or an acrylic resin having an amino group with a hydrogen atom bonded to a hydroxy group and/or at least one nitrogen atom.

That is, the crosslinkable polymer (C) is preferably a crosslinkable polymer (C1) having at least one type of substituent selected from the group consisting of a hydroxy group and —NHR (specific crosslinkable polymer (C1)). Here, R denotes a hydrogen atom, a straight-chain or branched alkyl group, an alkenyl group, an alkynyl group, a cycloalkyl group, an alkoxy group, an aryl group, or a heterocyclic group.

R in a substituent —NHR includes an alkyl group having 1 to 20 carbons as a straight-chain or branched chain alkyl group, an alkenyl group having 2 to 20 carbons as an alkenyl group, an alkynyl group having 2 to 20 carbons as an alkynyl group

R in a substituent —NHR includes a cycloalkyl group having 2 to 7 carbons as a cycloalkyl group, an alkoxy group having 1 to 20 carbons as an alkoxy group, and an aryl group having 6 to 20 carbons as an aryl group.

R in a substituent —NHR includes a hydrogen, a straight-chain or branched chain alkyl group having 1 to 5 carbons, an alkoxy group having 1 to 5 carbons, and an aryl group having 6 to 12 carbons.

The polymer skeleton of the specific crosslinkable polymer (C1) is not particularly limited; examples thereof include polyether, polyester, polyamide, polyurea, polyurethane, polysiloxane, an acrylic resin, an epoxy resin, and a polymer of a vinyl monomer (hereinafter, also called a vinyl polymer). In the present invention an acrylic resin denotes a polymer having at least one type of (meth)acrylic monomer as a polymerization component.

The substitution position of the hydroxyl group and —NHR in the specific crosslinkable polymer (C1) is not particularly limited; examples thereof include an embodiment in which it is present at a main chain terminal or in a side chain of the specific crosslinkable polymer (C1). From the viewpoint of reactivity, ease of synthesis, etc. the specific crosslinkable polymer (C1) is preferably a polymer having the above group in a side chain.

As the specific crosslinkable polymer (C1), one having at least one of a hydroxy group and —NHR at the main chain terminal of the main chain skeleton or in a side chain as shown above as examples may be used. A hydroxy group-containing specific crosslinkable polymer (C1) is particularly preferable.

As the specific crosslinkable polymer (C1), one in which a polymer such as polybutadiene, polyisoprene, or a polyolefin has its terminal hydroxylated is also preferably used. Such polymers are commercially available, and examples thereof include the Poly bd (registered trademark), Poly ip (registered trademark), Epol (registered trademark), and KRASOL series manufactured by Idemitsu Kosan Co., Ltd.

As the crosslinkable polymer (C1), a polymer compound having at least one substituent selected from the group consisting of hydroxyl group and —NHR in a polymer side chain, an acrylic resin, an epoxy resin, a vinyl polymer containing hydroxyethylene unit, a polyester or a polyurethane is preferable, and from the viewpoint of rinsing properties and printing durability for crosslinked relief-forming layer, at least one selected from the group consisting of an acrylic resin and a polyvinyl acetal is more preferable, and a polyvinyl butyral is particularly preferable.

Among the specific crosslinkable polymers (C1) used in the present invention, a polymer compound containing a hydroxy group in a polymer side chain is explained.

Examples of the polymer compound containing a hydroxy group in a polymer side chain include an acrylic resin containing a hydroxy group in a side chain, an epoxy resin containing a hydroxy group in a side chain, a polyester containing a hydroxy group in a side chain, and a vinyl polymer containing a hydroxy group in a side chain.

As an acrylic monomer used in synthesis of the acrylic resin having a hydroxyl group in a side chain, for example, a (meth)acrylic acid ester, a crotonic acid ester, or a (meth)acrylamide that has a hydroxy group in the molecule is preferable. Specific examples of such a monomer include 2-hydroxyethyl(meth)acrylate, 2-hydroxypropyl(meth)acrylate, and 4-hydroxybutyl(meth)acrylate. A copolymer formed by polymerization between the above and a known (meth)acrylic-based monomer or vinyl-based monomer may preferably be used.

Further, as an acrylic resin, acrylic monomer other than above-mentioned acrylic monomer having a hydroxy group may be used as a copolymer component.

Specific examples of the above-mentioned (meth)acrylic monomer include methyl(meth)acrylate, ethyl(meth)acrylate, n-propyl(meth)acrylate, isopropyl(meth)acrylate, n-butyl(meth)acrylate, isobutyl(meth)acrylate, tert-butyl(meth)acrylate, n-hexyl(meth)acrylate, lauryl(meth)acrylate, 2-ethylhexyl(meth)acrylate, acetoxyethyl(meth)acrylate, phenyl(meth)acrylate, 2-methoxyethyl(meth)acrylate, 2-ethoxyethyl(meth)acrylate, 2-(2-methoxyethoxy)ethyl(meth)acrylate, cyclohexyl(meth)acrylate, t-butylcyclohexyl(meth)acrylate benzyl(meth)acrylate, diethylene glycol monomethyl ether(meth)acrylate, diethylene glycol monoethyl ether(meth)acrylate, diethylene glycol monophenyl ether(meth)acrylate, triethylene glycol monomethyl ether(meth)acrylate, triethylene glycol monoethyl ether(meth)acrylate, dipropylene glycol monomethyl ether(meth)acrylate, polyethylene glycol monomethyl ether(meth)acrylate, polypropylene glycol monomethyl ether(meth)acrylate, the monomethyl ether(meth)acrylate of a copolymer of ethylene glycol and propylene glycol, N,N-dimethylaminoethyl(meth)acrylate, N,N-diethylaminoethyl(meth)acrylate, and N,N-dimethylaminopropyl(meth)acrylate.

Furthermore, a modified acrylic resin formed with a urethane group- or urea group-containing acrylic monomer may preferably be used.

Among these, from the viewpoint of aqueous ink resistance, an alkyl(meth)acrylate such as lauryl(meth)acrylate and an aliphatic cyclic structure-containing (meth)acrylate such as t-butylcyclohexyl(meth)acrylate are particularly preferable.

Specific example of an epoxy resin having a hydroxy group in a side chain includes an epoxy resin formed by polymerization, as a starting material monomer, of an adduct of bisphenol A and epichlorohydrin. The epoxy resin preferably has a weight-average molecular weight of at least 800 but no greater than 200,000, and a number-average molecular weight of at least 400 but no greater than 60,000.

As a polyester resin, a hydroxylcarboxylic acid unit-containing polyester resin such as polylactic acid may preferably be used. As such a polyester resin, specifically, one selected from the group consisting of a polyhydroxyalkanoate (PHA), a lactic acid-based polymer, polyglycolic acid (PGA), polycaprolactone (PCL), poly(butylene succinate), derivatives thereof, and mixtures thereof is preferable.

Furthermore, as a hydroxyethylene unit-containing vinyl-based polymer, polyvinyl alcohol (PVA) and derivatives thereof are preferably used.

Examples of the PVA derivatives include an acid-modified PVA in which at least some of the hydroxyl groups of the hydroxyethylene units are modified with an acid group such as a carboxy group, a modified PVA in which some of the hydroxy groups are modified with a (meth)acryloyl group, a modified PVA in which at least some of the hydroxy groups are modified with an amino group, a modified PVA in which at least some of the hydroxy groups have introduced thereinto ethylene glycol, propylene glycol, or a multimer thereof, and a polyvinyl acetal obtained by treating polyvinyl alcohol with an aldehyde.

Among these, polyvinyl acetal is particularly preferably used.

The polyvinyl acetal is a compound obtained by converting polyvinyl alcohol (obtained by saponifying polyvinyl acetate) into a cyclic acetal.

The acetal content in the polyvinyl acetal (mole % of vinyl alcohol units converted into acetal with the total number of moles of vinyl acetate monomer starting material as 100%) is preferably 30 to 90%, more preferably 50 to 85%, and particularly preferably 55 to 78%.

The vinyl alcohol unit in the polyvinyl acetal is preferably 10 to 70 mole % relative to the total number of moles of the vinyl acetate monomer starting material, more preferably 15 to 50 mole %, and particularly preferably 22 to 45 mole %.

Furthermore, the polyvinyl acetal may have a vinyl acetate unit as another component, and the content thereof is preferably 0.01 to 20 mole %, and more preferably 0.1 to 10 mole %. The polyvinyl acetal may further have another copolymerization unit.

Examples of the polyvinyl acetal include polyvinyl butyral, polyvinyl propylal, polyvinyl ethylal, and polyvinyl methylal. Among them, polyvinyl butyral is a PVA derivative that is particularly preferably used.

As an aldehyde used for an acetal treatment, acetaldehyde or butyraldehyde is preferably used because of ease of handling.

As the polyvinyl butyral, the Denka Butyral series manufactured by Denki Kagaku Kogyo Kabushiki Kaisha may preferably be used.

From the viewpoint of availability as a commercial product and alcohol solubility (particularly in ethanol), preferable examples of the polyvinyl butyral include the ‘S-LEC B’ series and the ‘S-LEC K(KS)’ series manufactured by Sekisui Chemical Co., Ltd. From the viewpoint of alcohol solubility (particularly in ethanol), the ‘S-LEC B’ series manufactured by Sekisui Chemical Co., Ltd. and ‘Denka Butyral’ manufactured by Denki Kagaku Kogyo Kabushiki Kaisha are more preferable; among the ‘S-LEC B’ series, ‘BL-1’, ‘BL-1H’, ‘BL-2’, ‘BL-5’, ‘BL-S’, ‘BX-L’, ‘BM-S’, and ‘BH-S’ are particularly preferable, and among the ‘Denka Butyral’ manufactured by Denki Kagaku Kogyo Kabushiki Kaisha ‘#3000-1’, ‘#3000-2’, ‘#3000-4’, ‘#4000-2’, ‘#6000-C’, ‘#6000-EP’, ‘#6000-CS’, and ‘#6000-AS’ are particularly preferable.

Furthermore, as the crosslinkable polymer (C1) having a hydroxyl group in a side chain, a novolac resin may be used, this being a resin formed by condensation of a phenol and an aldehyde under acidic conditions.

Preferred examples of the novolac resin include a novolac resin obtained from phenol and formaldehyde, a novolac resin obtained from m-cresol and formaldehyde, a novolac resin obtained from p-cresol and formaldehyde, a novolac resin obtained from o-cresol and formaldehyde, a novolac resin obtained from octylphenol and formaldehyde, a novolac resin obtained from mixed m-/p-cresol and formaldehyde, and a novolac resin between a mixture of phenol/cresol (any of m-, p-, o- or m-/p-, m-/o-, o-/p-mixtures) and formaldehyde.

With regard to these novolac resins, those having a weight-average molecular weight of 800 to 200,000 and a number-average molecular weight of 400 to 60,000 are preferable.

The content of the hydroxy group contained in the crosslinkable polymer (C1) used in the present invention is preferably 0.1 to 15 mmol/g, and more preferably 0.5 to 7 mmol/g.

Among the crosslinkable polymers (C1), a polymer having —NHR in a polymer side chain is now explained. As the polymer compound having —NHR in a polymer side chain, an acrylic resin is preferable. For example, a polymer having acrylamide as a polymerization component, a polymer in which a carboxyl group of an acrylic acid copolymer is aminoalkylated, etc. are preferable. Such polymers are commercially available, and examples thereof include the Polyment (registered trademark) series manufactured by Nippon Shokubai Co., Ltd.

In the present invention, for a polymer in any of the above-mentioned embodiments the —NHR group content in the specific crosslinkable polymer (C1) is preferably 0.1 to 15 mmol/g, and more preferably 0.5 to 7 mmol/g.

In the resin composition for a relief-forming layer of the present invention, a crosslinkable group in the crosslinking agent (B) reacts with a hydroxy group and/or an —NHR group, which are crosslinkable groups, in the crosslinkable polymer (C), crosslinkable polymer (C) molecules are three-dimensionally crosslinked with each other by means of the polyfunctional crosslinking agent (B), and the crosslinked relief-forming layer thus obtained has excellent film elasticity. Furthermore, a flexographic printing plate obtained by laser-engraving a crosslinked relief-forming layer obtained from the above resin composition has excellent ink transfer properties and printing durability.

Furthermore, it is surmised that since a bond that contributes to the three-dimensional crosslinked structure formed by a reaction between a crosslinking group in the crosslinking agent (B) and a hydroxy group or an —NHR group in the crosslinkable polymer (C) has a relatively weak bond strength and is easily cleaved by laser engraving, the engraving sensitivity becomes high.

In the present invention, the individual amounts added of components A to C in the resin composition total solids content are as described above. A preferred combination of ranges of individual components added corresponds to the more preferred ranges.

For example, it is preferable that, of the resin composition total solids content, the chain-polymerizable monomer (A) is 8 to 20 mass %, the crosslinking agent (B) is 5 to 30 mass %, and the crosslinkable polymer (C) is 20 to 60 mass %.

Furthermore, when a plasticizer (F) is contained as an optional component, it is preferable that, of the resin composition total solids content, the chain-polymerizable monomer (A) is 8 to 20 mass %, the crosslinking agent (B) is 5 to 30 mass %, the crosslinkable polymer (C) is 20 to 60 mass %, and the plasticizer (F) is 10 to 30 mass %.

The thermopolymerization initiator (D) is preferably 0.1 to 3 mass % in the resin composition total solids content, a photothermal conversion agent (E), which is described later, for example carbon black, is preferably 1 to 5 mass %, and a plasticizer, for example an ester compound having a boiling point of 200° C. to 450° C., is preferably 10 to 30 mass %.

### <(E) Photothermal Conversion Agent>

In the present invention, the crosslinked relief-forming layer preferably further comprises a photothermal conversion agent.

It is surmised that the photothermal conversion agent absorbs laser light and generates heat thus promoting thermal decomposition of a cured material of the resin composition for laser engraving of the present invention. Because of this, it is preferable to select a photothermal conversion agent that absorbs light having the wavelength of the laser that is used for engraving.

When a laser (a YAG laser, a semiconductor laser, a fiber laser, a surface emitting laser, etc.) emitting infrared at a wavelength of 700 to 1,300 nm is used as a light source for laser engraving, it is preferable for the relief-forming layer for the crosslinked relief-forming layer usable in the present invention to comprise a photothermal conversion agent that can absorb light having a wavelength of 700 to 1,300 nm.

As the photothermal conversion agent in the present invention, various types of dye or pigment are used.

With regard to the photothermal conversion agent, examples of dyes that can be used include commercial dyes and known dyes described in publications such as ‘Senryo Binran’ (Dye Handbook) (Ed. by The Society of Synthetic Organic Chemistry, Japan, 1970). Specific examples preferably include dyes having a maximum absorption wavelength at 700 to 1,300 nm, such as azo dyes, metal complex salt azo dyes, pyrazolone azo dyes, naphthoquinone dyes, anthraquinone dyes, phthalocyanine dyes, carbonium dyes, diimmonium compounds, quinone imine dyes, methine dyes, cyanine dyes, squarylium colorants, pyrylium salts, and metal thiolate complexes. Examples of dyes that can be used in the present invention include cyanine-based dyes such as heptamethine cyanine dyes, oxonol-based dyes such as pentamethine oxonol dyes, phthalocyanine-based dyes, and dyes described in paragraphs 0124 to 0137 of JP-A-2008-63554.

With regard to the photothermal conversion agent used in the present invention, examples of pigments include commercial pigments and pigments described in the Color Index (C.I.) Handbook, ‘Saishin Ganryo Binran’ (Latest Pigments Handbook) (Ed. by Nippon Ganryo Gijutsu Kyokai, 1977), ‘Saisin Ganryo Ouyogijutsu’ (Latest Applications of Pigment Technology) (CMC Publishing, 1986), ‘Insatsu Inki Gijutsu’ (Printing Ink Technology) (CMC Publishing, 1984). Examples include pigments described in paragraphs 0122 to 0125 of JP-A-2009-178869. Among these pigments, carbon black is preferable.

Any carbon black, regardless of classification by ASTM and application (e.g. for coloring, for rubber, for dry cell, etc.), may be used as long as dispersibility, etc. in the resin composition is stable. Carbon black includes for example furnace black, thermal black, channel black, lamp black, and acetylene black. In order to make dispersion easy, a black colorant such as carbon black may be used as color chips or a color paste by dispersing it in nitrocellulose or a binder in advance using, as necessary, a dispersant, and such chips and paste are readily available as commercial products. Examples include carbon blacks described in paragraphs 0130 to 0134 of JP-A-2009-178869.

In case that the crosslinked relief-forming layer comprises a photothermal conversion agent, preferably a carbon black, the content of the photothermal conversion agent largely depends on the size of the molecular extinction coefficient characteristic to the molecule, and is preferably 0.01 to 30 wt % relative to the total weight of the solids content of the resin composition forming the crosslinked relief-forming layer, more preferably 0.05 to 20 wt %, and yet more preferably 0.1 to 10 wt %, and particularly preferably 1 to 5 wt %.

### <(F) Plasticizer>

The flexographic printing plate precursor of the present invention preferably comprises a plasticizer.

As the plasticizer, an ester compound having a boiling point of 200° C. to 450° C. is preferable.

In order to maintain flexible film physical properties while having a network due to chain polymerization of polyfunctional monomer and crosslinking of polymers, the plasticizer is preferably 10% to 50% of the total solids content concentration, more preferably 10% to 40%, and particularly preferably 10% to 30%. The plasticizer is preferably a carboxylic acid ester, a phosphoric acid ester, or a sulfonic acid ester, and particularly preferably a carboxylic acid ester or a phosphoric acid ester. It is preferable for the plasticizer to be present stably in the film when thermally crosslinking, to easily evaporate when laser engraving, and to have an appropriate boiling point. The boiling point of the plasticizer is preferably 200° C. to 450° C., more preferably 250° C. to 400° C., and particularly preferably 300° C. to 350° C.

### <Other Additives>

The resin composition for the crosslinked relief-forming layer usable in the present invention may comprise as appropriate various types of additives that are usually used in the rubber field as long as the effects of the present invention are not inhibited. Examples include a filler, a plasticizer, a wax, a process oil, an organic acid, a metal oxide, an antiozonant, an anti-aging agent, a thermopolymerization inhibitor, and a colorant, and one type thereof may be used on its own or two more types may be used in combination.

When a process oil is used, examples include an aromatic-based process oil, a naphthene-based process oil, and a paraffin-based process oil. The amount thereof added is preferably 1 to 70 parts by weight per 100 parts by weight of the rubber component (Component B).

The organic acid may be used in the form of a metal salt as an adjuvant for promotion of vulcanization in combination with a standard vulcanizing agent. Examples of the organic acid include stearic acid, oleic acid, and murastic acid. Examples of a metal source used in combination include metal oxides such as zinc oxide (flowers of zinc) and magnesium oxide. It is thought that an organic acid and a metal oxide form a metal salt in rubber during a vulcanization step, thus promoting activation of a vulcanizing agent such as sulfur. In order to form such a metal salt in the system, the amount of metal oxide added is preferably 0.1 to 10 parts by weight per 100 parts by weight of the rubber component (Component B), and more preferably 2 to 10 parts by weight.

The amount of organic acid added is preferably 0.1 to 5 parts by weight per 100 parts by weight of the rubber component (Component B), and more preferably 0.1 to 3 parts by weight.

### (Relief Printing Plate Precursor for Laser Engraving)

A first embodiment of the relief printing plate precursor for laser engraving of the present invention comprises a relief-forming layer formed from the resin composition for laser engraving of the present invention.

In the present invention, the ‘relief-forming layer’ means a layer in a state before being crosslinked, that is, a layer formed from the resin composition for laser engraving of the present invention, which may be dried as necessary.

In the present invention, the ‘crosslinked relief-forming layer’ means a layer formed by crosslinking the relief-forming layer. The crosslinking is preferably carried out by means of heat and/or light. Furthermore, the crosslinking is not particularly limited as long as it is a reaction by which the resin composition is cured, and it is a concept that includes a structure crosslinked due to reactions between Component B's, but it is preferable to form a crosslinked structure by a reaction between Component B and other Component.

The ‘relief printing plate’ is prepared by laser engraving a printing plate precursor having a crosslinked relief-forming layer.

Moreover, in the present invention, the ‘relief layer’ means a layer of the relief printing plate formed by engraving using a laser, that is, the crosslinked relief-forming layer after laser engraving.

### <Crosslinked Relief-Forming Layer>

The crosslinked relief-forming layer is a layer formed from the resin composition for the relief-forming layer of the present invention and is a thermally crosslinkable layer. With regard to the relief printing starting plate for laser engraving of the present invention, it is preferable for it to further contain (Component G-1) a polymerizable compound and (Component G-2) a thermopolymerization initiator in addition to a crosslinked structure formed from Component B and Component A and/or Component C since one having a relief-forming layer to which further crosslinkable functionality is imparted is obtained.

As a mode for preparing a relief printing plate precursor, there is a flexographic printing plate precursor having a crosslinked relief-forming layer formed by crosslinking the resin composition by subjecting it to chain polymerization and step-growth crosslinking reactions. By subjecting the flexographic printing plate precursor thus obtained to laser engraving, a relief printing plate having a relief layer is prepared. Since the relief-forming layer is formed by crosslinking by means of two different crosslinking reactions, it is possible to prevent wear of the relief layer during printing and to obtain a relief printing plate having a relief layer with a sharp shape after laser engraving.

The crosslinked relief-forming layer may be formed by molding the resin composition for a relief-forming layer into a sheet or sleeve shape. The crosslinked relief-forming layer is usually provided above a support, which is described later, but the crosslinked relief-forming layer may be used by peeling it off from the support and directly forming or arranging and immobilizing it on the surface of a member such as a cylinder of a plate-making or printing apparatus, and it is not always necessary for the support to be the same one from production to application.

A case in which mainly the relief-forming layer is formed into a sheet shape is explained as an example below.

The relief printing plate precursor of the present invention comprises a crosslinked relief-forming layer formed by crosslinking a resin composition comprising the above-mentioned components. The crosslinked relief-forming layer is provided above a support.

The relief printing plate precursor for laser engraving may comprise as necessary an adhesive layer between the support and the crosslinked relief-forming layer and, furthermore, a slip coat layer and a protection film above the crosslinked relief-forming layer.

### <Support>

Materials usable as a support of the relief printing plate precursor of the present invention is explained below.

A material used for the support of the relief printing plate precursor for laser engraving is not particularly limited, but one having high dimensional stability is preferably used, and examples thereof include metals such as steel, stainless steel, or aluminum, plastic resins such as a polyester (e.g. PET (polyethylene terephthalate), PBT (polybutylene terephthalate), or PAN (polyacrylonitrile)) or polyvinyl chloride, synthetic rubbers such as styrene-butadiene rubber, and glass fiber-reinforced plastic resins (epoxy resin, phenolic resin, etc.). As the support, a PET film or a steel substrate is preferably used. The configuration of the support depends on whether the crosslinked relief-forming layer is in a sheet shape or a sleeve shape.

### <Adhesive Layer>

An adhesive layer may be provided between the crosslinked relief-forming layer and the support for the purpose of strengthening the adhesion between the two layers. Examples of materials (adhesives) that can be used in the adhesive layer include those described in ‘Handbook of Adhesives’, Second Edition, Ed by I. Skeist, (1977).

### <Protection Film, Slip Coat Layer>

For the purpose of preventing scratches or dents in the relief-forming layer surface or the crosslinked relief-forming layer surface, a protection film may be provided on the relief-forming layer surface or the crosslinked relief-forming layer surface. The thickness of the protection film is preferably 25 to 500 μm, and more preferably 50 to 200 μm. The protection film may employ, for example, a polyester-based film such as PET or a polyolefin-based film such as PE (polyethylene) or PP (polypropylene). The surface of the film may be made matte. The protection film is preferably peelable.

When the protection film is not peelable or conversely has poor adhesion to the relief-forming layer, a slip coat layer may be provided between the two layers. The material used in the slip coat layer preferably employs as a main component a resin that is soluble or dispersible in water and has little tackiness, such as polyvinyl alcohol, polyvinyl acetate, partially saponified polyvinyl alcohol, a hydroxyalkylcellulose, an alkylcellulose, or a polyamide resin.

### (Process for Producing Relief Printing Plate Precursor)

Formation of a relief-forming layer in the relief printing plate precursor is not particularly limited, and examples thereof include a method in which the resin composition for the relief-forming layer is prepared, solvent is removed as necessary from this resin composition for the relief-forming layer, and it is melt-extruded onto a support. Alternatively, a method may be employed in which the resin composition for laser engraving is cast onto a support, and this is dried in an oven to thus remove solvent from the resin composition.

Among them, the process for making a relief printing plate of the present invention is preferably a production process comprising a layer formation step of forming a relief-forming layer from the resin composition for the relief-forming layer of the present invention and a crosslinking step of crosslinking the relief-forming layer by means of chain polymerization and step-growth crosslinking reaction to thus obtain a relief printing plate precursor having a crosslinked relief-forming layer.

Subsequently, as necessary, a protection film may be laminated on the relief-forming layer. Laminating may be carried out by compression-bonding the protection film and the relief-forming layer by means of heated calendar rollers, etc. or putting a protection film into intimate contact with a relief-forming layer whose surface is impregnated with a small amount of solvent.

When a protection film is used, a method in which a relief-forming layer is first layered on a protection film and a support is then laminated may be employed.

When an adhesive layer is provided, it may be dealt with by use of a support coated with an adhesive layer. When a slip coat layer is provided, it may be dealt with by use of a protection film coated with a slip coat layer.

### <Layer Formation Step>

The process for making the relief printing plate for laser engraving of the present invention preferably comprises a layer formation step of forming a relief-forming layer from the resin composition for the present invention.

Preferred examples of a method for forming a relief-forming layer include a method in which the resin composition for the relief-forming layer is prepared, solvent is removed as necessary from this resin composition for the relief-forming layer, and it is then melt-extruded onto a support and a method in which the resin composition for the relief-forming layer is prepared, the resin composition for the relief-forming layer is cast onto a support, and this is dried in an oven to thus remove the solvent.

The resin composition for the relief-forming layer may be produced by, for example, dissolving the crosslinking agent (B) and crosslinkable polymer (C) which are crosslinkable by means of the step-growth reaction, and as optional components (E) a photothermal conversion agent, a plasticizer (F), aroma, etc., in an appropriate common solvent, and after that, dissolving the chain-polymerizable monomer (A) and polymerization initiator (D). Since it is preferable to remove most of the solvent component in a stage of producing a relief printing plate precursor, it is preferable to use as the solvent a volatile low-molecular-weight alcohol (e.g. methanol, ethanol, n-propanol, isopropanol, propylene glycol monomethyl ether), etc., and adjust the temperature, etc. to thus reduce as much as possible the total amount of solvent to be added.

The thickness of the crosslinked relief-forming layer in the flexographic printing plate precursor before and after crosslinking is preferably at least 0.05 mm but no greater than 10 mm, more preferably at least 0.05 mm but no greater than 7 mm, and particularly at least 0.05 mm but no greater than 3 mm.

### <Crosslinking Step>

### (Thermal Crosslinking)

It is preferable to carry out a crosslinking step of carrying out crosslinking by a thermal reaction (thermal crosslinking) after a step of forming a relief-forming layer. In the case of photocrosslinking, there is a restriction due to the absorbance of the resin composition for laser engraving, and it is difficult to uniformly crosslink a film having a thickness of about 1 mm. For example, in the case of a resin composition for laser engraving containing carbon black, since it is difficult for excitation light for photocrosslinking to reach the interior of the resin composition, thermal crosslinking is preferable.

In order to obtain desired plate physical properties by a crosslinking reaction of components A to C, it is important to regulate the reaction rate of radical chain polymerization between polyfunctional ethylenically unsaturated compounds (A1) themselves and the reaction rate of a step-growth crosslinking reaction between the crosslinking agent (B) and the crosslinkable polymer (C). When the final amount of the polyfunctional monomer that has undergone the chain polymerization reaction is A1, the amount of the crosslinkable polymer (C) that has undergone the crosslinking reaction is B1, and the amounts thereof reacted in the initial stage of heating are A and B, in terms of realizing the above-mentioned plate physical properties it is preferable to carry out reactions so that A/A1>B/B1 is satisfied. That is, it is preferable that the crosslinked structure is formed by carrying out chain polymerization of the polyfunctional ethylenically unsaturated compound (A1) at a relatively high rate in the initial stage of crosslinking, and the step-growth crosslinking reaction of the crosslinkable polymer (C) is carried out in the crosslinked structure.

As a method for realizing such a relationship between the rates of the two crosslinking reactions, the ratio of the rates of the two reactions, that is, chain polymerization of the polyfunctional ethylenically unsaturated compound (A1) and the crosslinking reaction of the crosslinkable polymer (C), is varied between the reaction initial stage and the reaction final stage by controlling the heating temperature by utilizing a difference in temperature dependence of the two, or by controlling the amount of catalyst used in the two crosslinking reactions. The temperature dependence of chain polymerization of the polyfunctional ethylenically unsaturated compound (A1) may be controlled by selecting polymerization initiators having different decomposition temperatures.

Specifically, there is a method in which as a first stage heating is carried out under first heating conditions in which the polyfunctional ethylenically unsaturated compound (A1) easily undergoes a radical polymerization reaction, and as a second stage a step-growth crosslinking reaction of the crosslinkable polymer (C) progresses. In this process, the temperature dependence of the initiating ability of a radical polymerization initiator is selected, and it is preferable to combine a plurality of polymerization initiators.

### (Mechanical Properties of Crosslinked Relief-Forming Layer)

In the flexographic printing plate precursor of the present invention, the mechanical properties and thermophysical properties (the two are together called ‘plate physical properties’) of a crosslinked relief-forming layer are very important properties for particularly high definition flexographic printing.

Since a load is concentrated on a small dot having a high aspect ratio shape during flexographic printing, the amount of deformation due to stress tends to increase. When the amount of deformation due to stress is large, it is difficult to obtain a desired printing performance. The amount of deformation due to stress is determined by the stress and the elastic modulus of a flexographic printing plate. In flexographic printing, the time for which a stress is applied to each dot is determined by printing speed, plate body diameter, printing pressure, etc., and is approximately from 0.001 sec to 0.1 sec. Therefore, the elastic modulus necessary for flexographic printing can be calculated by measurement of dynamic viscoelasticity in the range of 10 Hz to 1,000 Hz, and the elastic modulus is expressed as a storage modulus (E′). In order to reduce the amount of deformation due to stress during printing, with the storage modulus (E′) at a room temperature of 25° C. and 100 Hz as a representative value, the storage modulus (E′) is preferably 1 MPa or greater. It is more preferably 3 MPa or greater, yet more preferably 5 MPa or greater, and particularly preferably 7 MPa or greater. Since the storage modulus (E′) depends on the temperature, it is necessary to appropriately carry out calibration of temperature in a dynamic viscoelasticity measurement. Moreover, the temperature displayed in a dynamic viscoelasticity measurement might be a value that is not exactly the temperature of the sample itself, and as a method for carrying out calibration of temperature, it is preferable to attach a thermocouple to the sample itself and measure the temperature.

On the other hand, it is clear that in an unengraved solid printed image area it is necessary for a flexographic plate shape to deform and follow the fine surface shape of a printing substrate in order to achieve uniform ink transfer. In order to follow fine asperities of a printing substrate in a solid printed image area, where it is difficult to apply printing pressure, it is preferable for the elastic modulus to be small. In order to achieve minimum necessary ink transfer properties, it is necessary for the storage modulus (E′) to be no greater than 30 MPa. It is preferable for it to be no greater than 25 MPa, yet more preferably no greater than 20 MPa, and particularly preferably no greater than 15 MPa.

Measurement of storage modulus (E′) is carried out using dynamic viscoelasticity measurement equipment. The equipment, sample, measurement conditions, etc. may be referred to in JISK7244-1.

In the present invention, in order to carry out printing with a small dot high aspect ratio shape, it has been established that toughness that is resistant to breaking is necessary. Since a load is easily concentrated on a small dot high aspect ratio shape, bending easily occurs. Increasing the tensile breaking strength and the elongation at break as an indicator for toughness can prevent bending of a small dot high aspect ratio shape. Tensile breaking strength is the stress required for tensile breaking, and elongation at break is the elongation when breaking occurs. In order to prevent a high aspect ratio convex shape of the smallest dot of a high definition image having a resolution of 2,400 dpi or greater from bending during printing, it has been established that the tensile breaking strength of a flexographic printing plate precursor is preferably 0.6 MPa or greater. It is more preferably 0.8 MPa or greater, yet more preferably 1 MPa or greater, and particularly preferably 1.5 MPa or greater. There is no particular upper limit, but it is generally no greater than 10 MPa.

Furthermore, it is necessary for maximum elongation L at tensile break to be 30% or greater. It is preferably 45% or greater, more preferably 60% or greater, and particularly preferably 80% or greater. There is no particular upper limit, but it is generally no greater than 300%.

Maximum elongation L at tensile break is measured using a tensile tester. The test is carried out in accordance with JIS K6251 with respect to the equipment, sample, measurement conditions, etc.

When the above-mentioned numerical ranges are represented by mathematical expressions, with regard to the flexographic printing plate precursor for laser engraving of the present invention, the storage modulus E′ (MPa) at 25° C. of the crosslinked relief-forming layer at a frequency of 100 Hz satisfies expression (a) below, and the maximum elongation L (%) at tensile break at 25° C. satisfies expression (b) below.

1≦E′≦30 (a)

30≦L≦300 (b)

The above-mentioned storage modulus E′ is measured at a frequency of 100 Hz at 25° C.

When the storage modulus E′ is less than 1 MPa, the amount of deformation of a small dot is large and the density of a halftone area is unstable, and when it exceeds 30 MPa the ink transfer properties of a solid printed area are degraded.

The above-mentioned maximum elongation L at tensile break is measured under temperature- and humidity-controlled conditions of a room temperature of 25° C. and a humidity of 40% to 60%. One example of the measurement method is shown in Examples.

When the maximum elongation L is less than 30%, a small dot easily bends, and when it exceeds 300% thermal deformation during laser engraving tends to occur easily.

It is preferable in this way that, while taking into consideration physical properties commensurate with an intended application, a resin composition for the relief-forming layer comprising a chain-polymerizable monomer (A), a crosslinking agent (B) that crosslinks in a step-growth reaction, and a crosslinkable polymer (C) having a crosslinkable group that reacts with the crosslinking agent (B) is prepared according to the intended purpose, and this is subjected to crosslinking by a chain polymerization reaction and a sequential crosslinking reaction to thus form a crosslinked relief-forming layer above a support.

The tensile breaking strength and elongation at break may be obtained by examining the relationship between stress and strain. Any measurement equipment may be used as long as it can measure stress and displacement at the same time, but one that is suitable for measuring a sample such as rubber exhibiting large elongation at low stress is preferable. Unless the temperature and humidity are particularly specified, these physical properties of a flexographic printing plate precursor are values measured under conditions of a room temperature of 23° C. to 25° C. and a humidity of 40% to 60%.

### <Thermophysical Properties of Flexographic Printing Plate Precursor>

In order to form a small dot high aspect ratio shape, it is necessary to prevent deformation due to heat transmitted to an area surrounding a part engraved by laser engraving. It is therefore preferable for the softening temperature (Tm) of the flexographic printing plate precursor to be high. However, it has been found that, when the amount of heat required for engraving is large, since the temperature of a surrounding area increases accordingly, a small dot high aspect ratio shape cannot be formed just by making the softening temperature high. The present inventors have found that it is most important for the softening temperature to be relatively high compared with the thermal decomposition temperature, that is, for the softening temperature (Tm) to be higher than the thermal decomposition temperature (Td), or it is necessary for it not to be lower than Td by 50° C. or greater. It is preferable for Tm not to be lower than Td by 20° C. or greater, and it is yet more preferable for Tm not to be lower than Td. By satisfying such a relationship between the thermal decomposition temperature (Td) and the softening temperature (Tm), a balance can be achieved between ablation due to irradiation with a laser and shape retention in surrounding areas.

Furthermore, since the larger the amount of heat required for engraving the slower the scanning speed needs to be, productivity is degraded. It is therefore preferable for the thermal decomposition temperature to be low. On the other hand, when a flexographic printing plate precursor is produced by thermal curing, it is necessary for the thermal decomposition temperature to be higher than the temperature of the thermal curing treatment. It is therefore preferable for the thermal decomposition temperature (Td) of a flexographic printing plate precursor to be 150° C. to 450° C. It is more preferably 150° C. to 350° C., and particularly preferably 200° C. to 300° C.

Thermal decomposition temperature (Td) and softening temperature (Tm) can be determined by thermogravimetric/differential thermal analysis (TG-DTA) measurement. In the present invention, the thermal decomposition temperature (Td) is defined as the temperature at which the weight decreases by 10%. Although it is necessary to differentiate Tm from glass transition temperature (Tg), in the case of a soft relief-forming layer such as a flexographic printing plate, since Tg is no greater than room temperature, by carrying out a thermogravimetric/differential thermal analysis (TG-DTA) measurement at a temperature of 30° C. or higher, confusion of Tg and Tm can be avoided. A substance absorbs heat upon melting or softening, and in differential thermal analysis measurement the temperature at which heat absorption occurs can be measured. In the present invention, a temperature at which a heat absorption peak at a temperature higher than 30° C. and lower than Td is exhibited is defined as Tm. When there are a plurality of heat absorption peaks, the temperature that is the closest to Td is defined as Tm. When there is no heat absorption peak observed, Tm can be considered to be higher than Td.

In the flexographic printing plate precursor for laser engraving of the present invention, when the above-mentioned relationships are represented by mathematical expressions, it is preferable for the thermal decomposition temperature (Td)(° C.) of the crosslinked relief-forming layer to satisfy expression (c) below, and for the softening temperature (Tm)(° C.) of the crosslinked relief-forming layer to be 200° C. or higher or to satisfy expression (d) below.

150≦Td≦350 (c)

Td≦Tm (d)

### (Relief Printing Plate and Process for Making Same)

In the present invention, the process for making a relief printing plate preferably comprises a laser-engraving step of laser-engraving the relief printing plate precursor.

The relief printing plate made by laser-engraving may suitably employ an aqueous ink when printing.

### <Engraving Step>

An engraving step in a method of making a relief printing plate is a step of laser-engraving a crosslinked relief-forming layer of a relief printing plate precursor for laser engraving to thus form a relief layer. Specifically, it is preferable to engrave a crosslinked relief-forming layer that has been crosslinked by irradiation with laser light according to a desired image, thus forming a relief layer. Furthermore, a step in which a crosslinked relief-forming layer is subjected to scanning irradiation by controlling a laser head using a computer in accordance with digital data of a desired image can preferably be cited.

This engraving step preferably employs an infrared laser. When irradiated with an infrared laser, molecules in the crosslinked relief-forming layer undergo molecular vibration, thus generating heat. When a high power laser such as a carbon dioxide laser or a YAG laser is used as the infrared laser, a large quantity of heat is generated in the laser-irradiated area, and molecules in the crosslinked relief-forming layer undergo molecular scission or ionization, thus being selectively removed, that is, engraved. The advantage of laser engraving is that, since the depth of engraving can be set freely, it is possible to control the structure three-dimensionally. For example, for an area where fine halftone dots are printed, carrying out engraving shallowly or with a shoulder prevents the relief from collapsing due to printing pressure, and for a groove area where a fine outline character is printed, carrying out engraving deeply makes it difficult for ink the groove to be blocked with ink, thus enabling breakup of an outline character to be suppressed.

In particular, when engraving is carried out using an infrared laser that corresponds to the absorption wavelength of the photothermal conversion agent, it becomes possible to selectively remove the crosslinked relief-forming layer at higher sensitivity, thus giving a relief layer having a sharp image.

As the infrared laser used in the engraving step, from the viewpoint of productivity, cost, etc., a carbon dioxide laser (CO₂ laser) or a semiconductor laser is preferable. In particular, a fiber-coupled semiconductor infrared laser (FC-LD) is preferably used. In general, compared with a CO₂ laser, a semiconductor laser has higher efficiency laser oscillation, is less expensive, and can be made smaller. Furthermore, it is easy to form an array due to the small size. Moreover, the shape of the beam can be controlled by treatment of the fiber.

With regard to the semiconductor laser, one having a wavelength of 700 to 1,300 nm is preferable, one having a wavelength of 800 to 1,200 nm is more preferable, one having a wavelength of 860 to 1,200 nm is yet more preferable, and one having a wavelength of 900 to 1,100 nm is particularly preferable.

In the present invention, the crosslinked relief-forming layer is thought to have a so-called IPN structure, and it is surmised that by controlling the interpenetration state in particular it becomes possible to carry out control so as to obtain preferred physical properties having printing suitability even for a small-dot high-aspect ratio relief shape.

Furthermore, the fiber-coupled semiconductor laser can output laser light efficiently by being equipped with optical fiber, and this is effective in the engraving step in the present invention. Moreover, the shape of the beam can be controlled by treatment of the fiber. For example, the beam profile may be a top hat shape, and energy can be applied stably to the plate face. Details of semiconductor lasers are described in ‘Laser Handbook 2^{nd} Edition’ (The Laser Society of Japan), ‘Jitsuyo Laser Gijutsu’ (Applied Laser Technology) (The Institute of Electronics and Communication Engineers), etc.

Moreover, a plate making equipment comprising a fiber-coupled semiconductor laser that can be used suitably in the process for making a relief printing plate of the present invention is described in detail in JP-A-2009-172658 and JP-A-2009-214334, and may be used for the method of making the relief printing plate according to the present invention.

The process for making a relief printing plate of the present invention may as necessary further comprise, subsequent to the engraving step, a rinsing step, a drying step, and/or a post-crosslinking step.

Rinsing step is a step of rinsing the engraved surface after engraving with water or a liquid containing water as a main component. Drying step is a step of drying the engraved relief layer. Post-crosslinking step is a step of further crosslinking the relief layer by applying energy to the engraved relief layer.

A process for making a flexographic printing plate comprising, subsequent to a step of laser-engraving the flexographic print printing plate precursor of the present invention, a step of washing the laser-engraved printing plate with water or an aqueous solution is preferable.

After the above-mentioned laser-engraving step, since engraving residue is attached to the surface of the relief layer, a rinsing step of washing off engraving residue by rinsing the surface with water or an aqueous liquid containing water as a main component may be preferably added. Examples of rinsing means include a method in which washing is carried out with tap water, a method in which high pressure water is spray-jetted, and a method in which the engraved surface is brushed in the presence of mainly water using a batch or conveyor brush type washout machine known as a photosensitive resin letterpress plate processor, and when slime due to engraving residue cannot be eliminated, a rinsing liquid to which a soap or a surfactant is added may be used.

When the rinsing step of rinsing the engraved surface is carried out, it is preferable to add a drying step of drying an engraved crosslinked relief-forming layer so as to evaporate rinsing liquid.

Furthermore, as necessary, a post-crosslinking step for further crosslinking the crosslinked relief-forming layer may be added. By carrying out the post-crosslinking step, which is an additional crosslinking step, it is possible to further strengthen the relief formed by engraving.

The pH of the rinsing liquid that can be used in the present invention is preferably at least 9, more preferably at least 10, and yet more preferably at least 11. The pH of the rinsing liquid is preferably no greater than 14, more preferably no greater than 13.2, yet more preferably no greater than 13.0, particularly preferably no greater than 12.5. When in the above-mentioned range, handling is easy.

In order to set the pH of the rinsing liquid in the above-mentioned range, the pH may be adjusted using an acid and/or a base as appropriate, and the acid or base used is not particularly limited.

The rinsing liquid that can be used in the present invention preferably comprises water as a main component.

The rinsing liquid may contain as a solvent other than water a water-miscible solvent such as an alcohol, acetone, or tetrahydrofuran.

The aqueous liquid mentioned above, that is a rinsing liquid, preferably comprises a surfactant.

From the viewpoint of removability of engraving residue and little influence on a relief printing plate, preferred examples of the surfactant that can be used in the present invention include betaine compounds (amphoteric surfactants) such as a carboxybetaine compound, a sulfobetaine compound, a phosphobetaine compound, an amine oxide compound, and a phosphine oxide compound.

The betaine compound is preferably a compound represented by Formula (1) below and/or a compound represented by Formula (2) below.

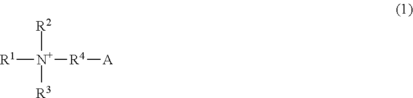

(In Formula (1), R¹ to R³ independently denote a monovalent organic group, R⁴ denotes a single bond or a divalent linking group, A denotes PO(OR⁵)O⁻, OPO(OR⁵)O⁻, O⁻, COO⁻, or SO₃⁻, R⁵ denotes a hydrogen atom or a monovalent organic group, and two or more groups of R¹ to R³ may be bonded to each other to form a ring.)

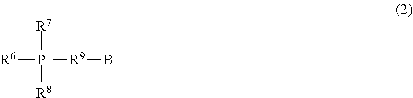

(In Formula (2), R⁶ to R⁸ independently denote a monovalent organic group, R⁹ denotes a single bond or a divalent linking group, B denotes PO(OR¹⁰)O⁻, OPO(OR¹⁹)O⁻, O⁻, COO⁻, or SO₃⁻, R¹⁰ denotes a hydrogen atom or a monovalent organic group, and two or more groups of R⁶ to R⁸ may be bonded to each other to form a ring.).

The compound represented by Formula (1) above or the compound represented by Formula (2) above is preferably a carboxybetaine compound, a sulfobetaine compound, a phosphobetaine compound, an amine oxide compound, or a phosphine oxide compound. In the present invention, the structures of N═O of an amine oxide compound and P═O of a phosphine oxide compound are considered to be N⁺—O⁻ and P⁺—O⁻ respectively.

R¹ to R³ in Formula (1) above independently denote a monovalent organic group. Two or more groups of R¹ to R³ may be bonded to each other to form a ring, but it is preferable that no ring is formed.

The monovalent organic group denoted by R¹ to R³ is not particularly limited, but is preferably an alkyl group, a hydroxy group-containing alkyl group, an alkyl group having an amide bond in an alkyl chain, or an alkyl group having an ether bond in an alkyl chain, and is more preferably an alkyl group, a hydroxy group-containing alkyl group, or an alkyl group having an amide bond in an alkyl chain.

Furthermore, the alkyl group as the monovalent organic group may have a straight-chain, branched, or cyclic structure.

Moreover, it is particularly preferable that two of R¹ to R³ are methyl groups, that is, a compound represented by Formula (1) has an N,N-dimethyl structure. When it has the above-mentioned structure, particularly good rinsing properties are exhibited . . . .

R⁴ in Formula (1) above denotes a single bond or a divalent linking group, and is a single bond when a compound represented by Formula (1) is an amine oxide compound.

The divalent linking group denoted by R⁴ is not particularly limited, and is preferably an alkylene group or a hydroxy group-containing alkylene group, more preferably an alkylene group having 1 to 8 carbons or a hydroxy group-containing alkylene group having 1 to 8 carbons, and yet more preferably an alkylene group having 1 to 3 carbons or a hydroxy group-containing-alkylene group having 1 to 3 carbons.

A in Formula (1) above denotes PO(OR⁵)O⁻, OPO(OR⁵)O⁻, O⁻, COO⁻, or SO₃⁻, and is preferably O⁻, COO⁻, or SO₃⁻, and more preferably COO⁻.

When A⁻ is O⁻, R⁴ is preferably a single bond.

R⁵ in PO(OR⁵)O⁻ and OPO(OR⁵)O⁻ denotes a hydrogen atom or a monovalent organic group, and is preferably a hydrogen atom or an alkyl group having one or more unsaturated fatty acid ester structures.

Furthermore, R⁴ is preferably a group that does not have PO(OR⁵)O⁻, OPO(OR⁵)O⁻, O⁻, COO⁻, or SO₃⁻.

R⁶ to R⁸ in Formula (2) above independently denote a monovalent organic group. Two or more groups of R⁶ to R⁸ may be bonded to each other to form a ring, but it is preferable that no ring is formed.

The monovalent organic group denoted by R⁶ to R⁸ is not particularly limited, but is preferably an alkyl group, an alkenyl group, an aryl group, or a hydroxy group, and more preferably an alkenyl group, an aryl group, or a hydroxy group.

Furthermore, the alkyl group as the monovalent organic group may have a straight-chain, branched, or cyclic structure.

It is particularly preferable that two of R⁶ to R⁸ are aryl groups.

R⁹ in Formula (2) above denotes a single bond or a divalent linking group, and is a single bond when a compound represented by Formula (2) is a phosphine oxide compound.

The divalent linking group denoted by R⁹ is not particularly limited, but is preferably an alkylene group or a hydroxy group-containing alkylene group, more preferably an alkylene group having 1 to 8 carbons or a hydroxy group-containing alkylene group having 1 to 8 carbons, and yet more preferably an alkylene group having 1 to 3 carbons or a hydroxy group-containing alkylene group having 1 to 3 carbons.

B in Formula (2) above denotes PO(OR¹⁰)O⁻, OPO(OR¹⁰)O⁻, O⁻, COO⁻, or SO₃⁻, and is preferably O⁻.

R⁹ is preferably a single bond when B⁻ is O⁻.

R¹⁰ in PO(OR¹⁰)O⁻ and OPO(OR¹⁰)O⁻ denotes a hydrogen atom or a monovalent organic group, and is preferably a hydrogen atom or an alkyl group having one or more unsaturated fatty acid ester structures.

Furthermore, R⁹ is preferably a group that does not have PO(OR¹⁰)O⁻, OPO(OR¹⁰)O⁻, O⁻, COO⁻, or SO₃⁻.

A compound represented by Formula (1) is preferably a compound represented by Formula (3) below.

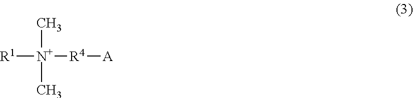

(In Formula (3), R¹ denotes a monovalent organic group, R⁴ denotes a single bond or a divalent linking group, A denotes PO(OR⁵)O⁻, OPO(OR⁵)O⁻, O⁻, COO⁻, or SO₃⁻, and R⁵ denotes a hydrogen atom or a monovalent organic group.)

R¹, A, and R⁵ in Formula (3) have the same meanings as R¹, A, and R⁵ in Formula (1) above, and preferred ranges are also the same.

A compound represented by Formula (2) is preferably a compound represented by Formula (4) below.

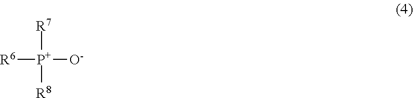

(In Formula (4), R⁶ to R⁸ independently denote an alkyl group, an alkenyl group, an aryl group, or a hydroxy group. In addition, not all of R⁶ to R⁸ are the same groups.)

R⁶ to R⁸ in Formula (4) above independently denote an alkyl group, an alkenyl group, an aryl group, or a hydroxy group, and are preferably an alkenyl group, an aryl group, or a hydroxy group.

Specific examples of the compound represented by Formula (1) and the compound represented by Formula (2) include the compounds below.

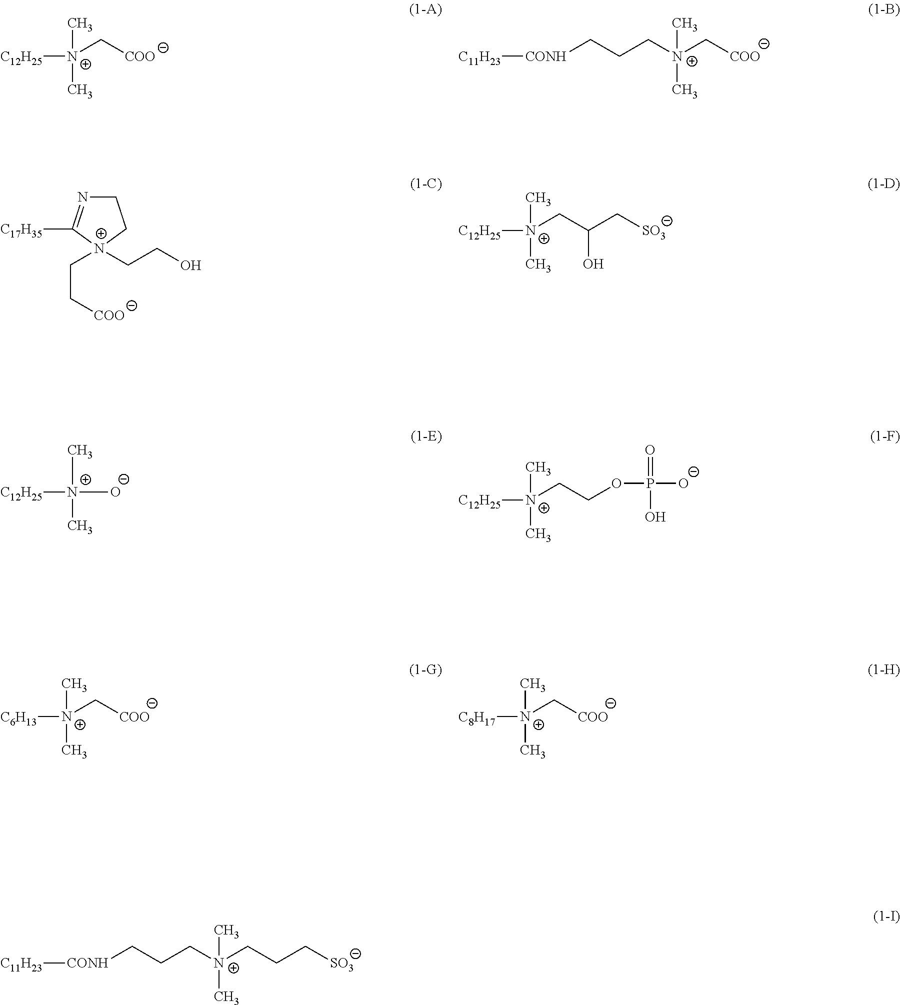

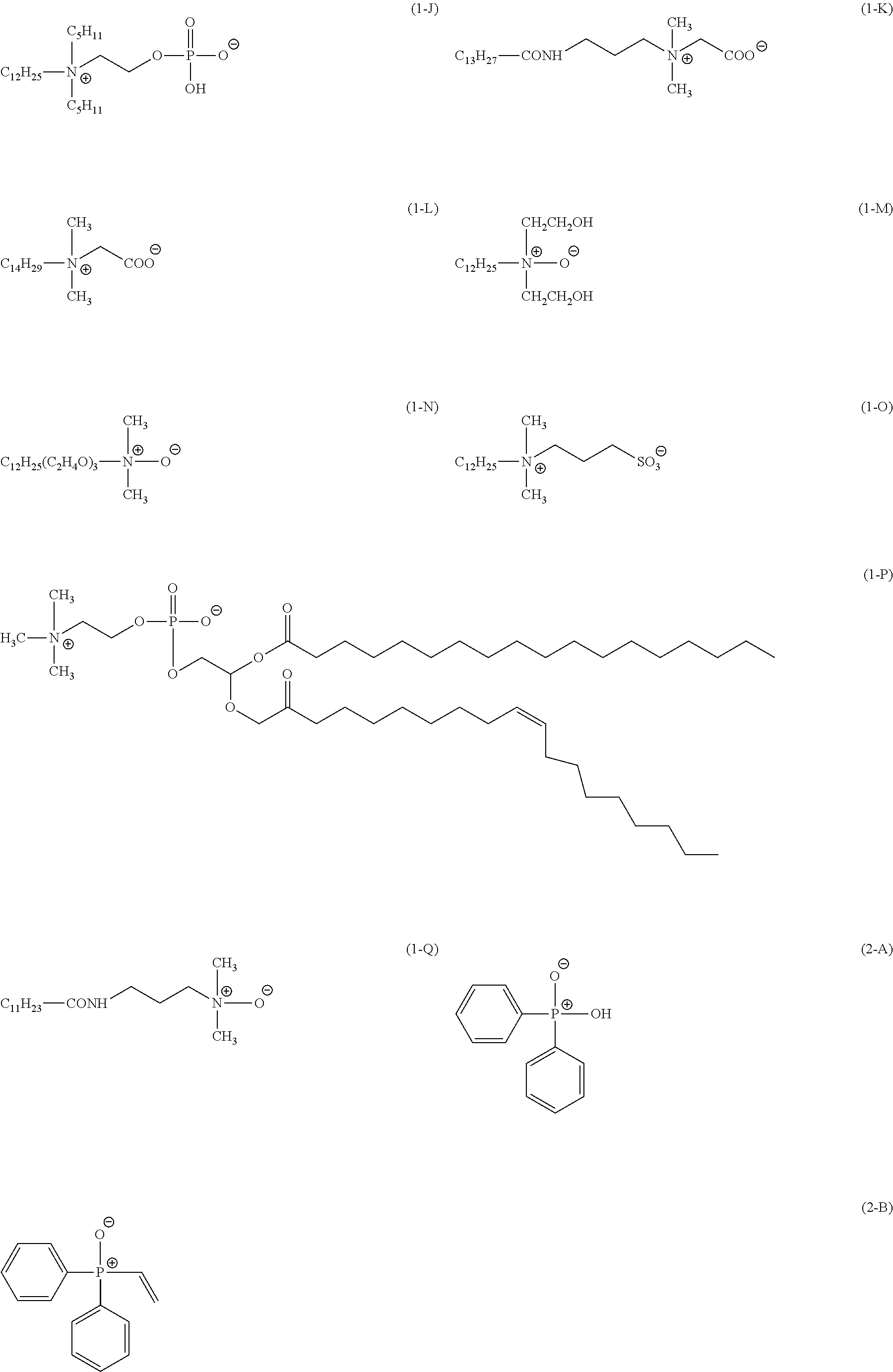

Furthermore, examples of the surfactant also include known anionic surfactants, cationic surfactants, amphoteric surfactants, and nonionic surfactants. Moreover, a fluorine-based or silicone-based nonionic surfactant may also be used in the same manner.

With regard to the surfactant, one type may be used on its own or two or more types may be used in combination.

It is not necessary to particularly limit the amount of surfactant used, but it is preferably 0.01 to 20 mass % relative to the total mass of the rinsing liquid, and more preferably 0.05 to 10 wt %.

The relief printing plate having a relief layer on the surface of any substrate such as a support etc. may be produced as described above.

From the viewpoint of satisfying suitability for various aspects of flexographic printing, such as abrasion resistance and ink transfer properties, the thickness of the relief layer of the relief printing plate is preferably at least 0.05 mm but no greater than 10 mm, more preferably at least 0.05 mm but no greater than 7 mm, and particularly preferably at least 0.05 mm but no greater than 3 mm.

Furthermore, a Shore A hardness of the relief layer of the relief printing plate is preferably at least 50° but no greater than 90°. When the Shore A hardness of the relief layer is at least 50°, even if fine halftone dots formed by engraving receive a strong printing pressure from a letterpress printer, they do not collapse and close up, and normal printing can be carried out. Furthermore, when the Shore A hardness of the relief layer is no greater than 90°, even for flexographic printing with kiss touch printing pressure it is possible to prevent patchy printing in a solid printed part.

The Shore A hardness in the present specification is a value measured by a durometer (a spring type rubber hardness meter) that presses an indenter (called a pressing needle or indenter) into the surface of a measurement target so as to deform it, measures the amount of deformation (indentation depth), and converts it into a numerical value.

### <Dot Properties>

The flexographic printing plate precursor of the present invention is preferably engraved by a diode laser.

Since the present invention aims for high resolution image formation, the pixel pitch is preferably no greater than 10.58 μm. In other words, the resolution is preferably at least 2,400 dpi. The dot diameter of the light beam is preferably no greater than 20 μm.

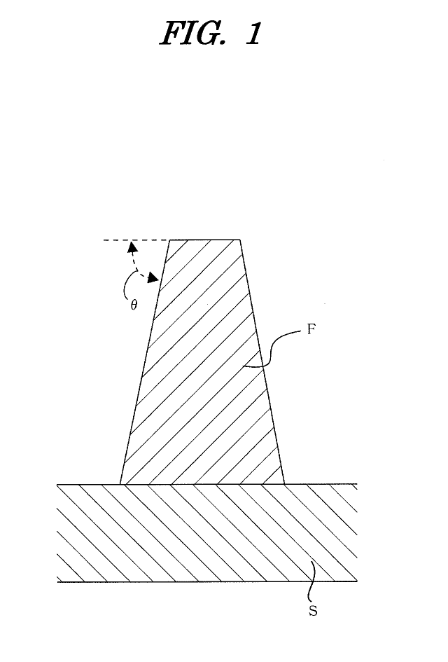

The cross-section of a relief printing plate is explained by reference to FIG. 1.

In FIG. 1, the relief-forming layer formed above a support S includes a small dot (smallest point) F (small halftone dot or narrow fine line).

A rectangular fine line and a rectangular halftone dot mean a shape having a desired line width, shape, and size for an upper part of a projecting part and having a nearly vertical inclined face, and in order to achieve high resolution image printing this cross-sectional shape is preferable. If the inclination of the inclined face is too close to the vertical, since breakage of the projecting shape easily occurs, the angle of inclination (angle of inclined face) 0 is preferably 45° to 88°, more preferably 60° to 86°, and particularly preferably 70° to 84°.

### EXAMPLES

The present invention is explained below by reference to Examples, but the present invention is not limited to the Examples below.

### Example 1

Formation of Flexographic Printing Plate Precursor

The crosslinking agent (B), the crosslinkable polymer (binder polymer) (C), plasticizer, and solvent, if used, described in Table 1 were mixed, and the mixture was charged into a three-necked flask equipped with a stirring blade and a condenser and dissolved by heating at 70° C. for 120 minutes while heating. The amount of solvent used was an amount corresponding to 22 wt % of the final composition.

Subsequently, the chain-polymerizable monomer (A), carbon black, and basic compound DBU were added, and stirring was carried out for a further 30 minutes. After the temperature of this solution was set at 40° C., the crosslinking agent and the initiator were added thereto, and stirring was carried out for a further 10 minutes, thus forming a flowable resin composition.

A 3 mm thick spacer (frame) was placed on a PET substrate, and the above-mentioned resin composition was maintained at 70° C. and cast gently so that it did not flow out of the spacer (frame).

### Examples 2 to 16 and Comparative Examples 17 to 22

Samples of Examples 2 to 16 and Comparative Examples 17 to 22 were prepared in the same manner as in Example 1 except that materials described in Table 1 were used.

TABLE 1

| | Crosslinking | | | | | | | | Crosslinking | | | | | | | |
|---|---|---|---|---|---|---|---|---|---|---|---|---|---|---|---|---|
| | polymer | | Plasticizer | | Polymerizable | | Polymerizable | | agent | | Initiator | | DBU | Carbon | | |
| Ex. or | | Parts | | Parts | monomer 1 | | monomer 2 | | | Parts | | Parts | Parts | black | | |
| Comp. | | by | | by | | Parts by | | Parts by | | by | | by | by | Parts | | Curing |
| Ex. C | Type | wt. | Type | wt. | Type | wt. | Type | wt. | Type | wt. | Type | wt. | wt. | by wt. | Solvent | method |
| 1 | PVB | 33 | TBC | 30 | A-DCP | 13 | | | S-2 | 19 | PBZ | 1 | 1 | 3 | PGMEA | A |
| 2 | PVB | 33 | TBC | 30 | DCP | 13 | | | S-2 | 19 | PBZ | 1 | 1 | 3 | PGMEA | A |
| 3 | PVB | 33 | TBC | 30 | A-1 | 13 | | | S-2 | 19 | PBZ | 1 | 1 | 3 | PGMEA | A |
| 4 | PVB | 33 | TBC | 30 | DPHA | 13 | | | S-2 | 19 | PBZ | 1 | 1 | 3 | PGMEA | A |
| 5 | PVB | 33 | TBEP | 30 | DPHA | 13 | | | S-2 | 19 | PBZ | 1 | 1 | 3 | PGMEA | A |
| 6 | PVB | 33 | TBEA | 30 | DPHA | 13 | | | S-2 | 19 | PBZ | 1 | 1 | 3 | PGMEA | A |
| 7 | PVB | 33 | DOP | 30 | DPHA | 13 | | | S-2 | 19 | PBZ | 1 | 1 | 3 | PGMEA | A |
| 8 | PVB | 33 | DBEA | 30 | DCP | 13 | | | S-2 | 19 | PBZ | 1 | 1 | 3 | PGMEA | A |
| 9 | PVB | 33 | DBEA | 30 | DCP | 13 | | | S-1 | 19 | PBZ | 1 | 1 | 3 | PGMEA | A |
| 10 | PVB | 33 | DBEA | 30 | DCP | 13 | | | S-3 | 19 | PBZ | 1 | 1 | 3 | PGMEA | A |
| 11 | PVB | 33 | DBEA | 30 | DPHA | 13 | | | S-2 | 19 | TMH | 1 | 1 | 3 | PGMEA | A |
| 12 | PVB | 33 | DBEA | 30 | DPHA | 13 | | | I-1 | 19 | PBZ | 1 | 1 | 3 | PGMEA | A |
| 13 | PVB | 33 | DBEA | 30 | DPHA | 13 | | | I-6 | 19 | PBZ | 1 | 1 | 3 | PGMEA | A |
| 14 | PVB | 33 | DBEA | 30 | DPHA | 13 | | | A-4 | 19 | PBZ | 1 | 1 | 3 | PGMEA | A |
| 15 | SI | 49 | DOP | 10 | IDA | 4 | HDDA | 16 | S-1 | 15 | PBZ | 2 | 1 | 3 | | A |
| 16 | SI | 49 | DOP | 10 | IDA | 4 | HDDA | 16 | S-3 | 15 | PBZ | 2 | 1 | 3 | | A |
| C17 | SI | 64 | DOP | 10 | IDA | 4 | HDDA | 16 | | | PBZ | 2 | 1 | 3 | | A |
| C18 | PVB | 57 | TBC | 15 | A-DCP | 13 | | | S-2 | 10 | PBZ | 1 | 1 | 3 | PGMEA | A |
| C19 | PVB | 49 | TBC | 15 | A-DCP | 13 | | | S-2 | 19 | PBZ | 1 | 0 | 3 | PGMEA | A |
| C20 | PVB | 34 | TBC | 30 | A-DCP | 13 | | | S-2 | 19 | PBZ | 1 | 0 | 3 | PGMEA | A |
| C21 | PVB | 33 | DBEA | 30 | DPHA | 13 | | | S-2 | 19 | PBO | 1 | 1 | 3 | PGMEA | A |
| C22 | PVB | 33 | DBEA | 30 | DPHA | 13 | | | S-2 | 19 | PBZ | 1 | 1 | 3 | PGMEA | B |

The materials used in the preparation of Examples 1 to 16 and Comparative Examples 17 to 22 were as follows.
PVB: polyvinyl butyral (Mw 90,000) (Denkabutyral #3000-2, Denki Kagaku Kogyo Kabushiki Kaisha)
SI: styrene isoprene block polymer Quintac 3421 (Zeon Corporation)
A-DCP: (Shin-Nakamura Chemical Co., Ltd.)

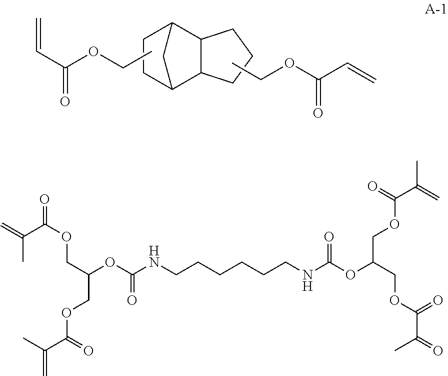

DCP: (Shin-Nakamura Chemical Co., Ltd.)

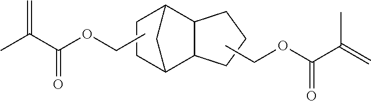

DPHA: dipentaerythritol hexaacrylate
IDA: isodecyl acrylate
HDDA: 1,6-hexanediol diacrylate
S-1: KBE3028 (Shin-Etsu Chemical Co., Ltd.)
S-2:

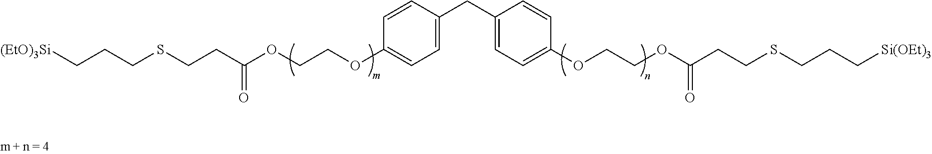

S-3:

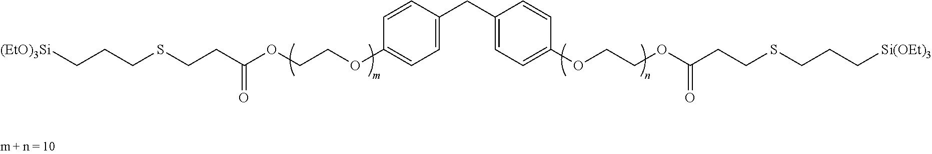

PBZ: Perbutyl Z (NOF Corporation)

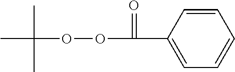

PGMEA: propylene glycol monomethyl acetate

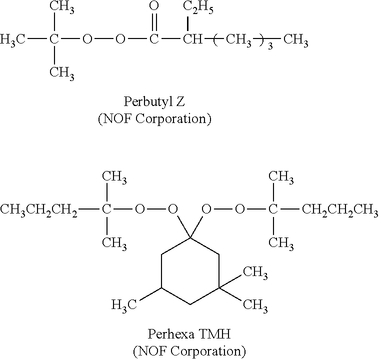

The chemical structure of crosslinking agent A-4 is illustrated as a polyfunctional acid anhydride.

As a plasticizer, tributyl citrate (TBC), trisbutoxyethyl phosphate (TBEP), dibutoxyethyl adipate (DBEA), or dioctyl phthalate (DOP) was used.

As a chain-polymerizable monomer, isodecyl acrylate (IDA) or 1,6-hexanediol diacrylate (HDDA) was used.

As curing method A, a coated material was placed in an oven, kept at 95° C. for 1 hour, and then heated at 85° C. for 3 hours.

As curing method B, a coated material was placed in an oven and heated at 85° C. for 8 hours.

### <Radical Initiator Half-Life Temperature>

The 10 hour half-life temperatures of the radical initiators used in the present invention were as follows.

### Perbutyl Z (PBZ): 110° C.

### Perhexa TMH (TMH): 85° C.

### Perbutyl 0 (PBO): 70° C.

### <Measurement of Physical Properties of Flexographic Plate Precursor>

Measurement conditions for the thermal decomposition temperature are shown below.

### <Equipment>

Thermogravimetric/differential thermal analysis (TG-DTA) system (EXSTAR TG/DTA 7000, SII)<

### <Measurement Conditions>

10 mg of a composition was weighed and heated at a rate of temperature increase of 10° C./min from 30° C. to 500° C., and the weight loss was measured. About 5 mg of a sample was placed in an alumina pan, the temperature was increased at 20° C./min, and the temperature at which a weight loss of 10% was observed was defined as the thermal decomposition temperature.

Measurement conditions for storage modulus (E′) and softening temperature (Tm) are shown below.

The equipment used for measurement of dynamic viscoelasticity (DMA) was a DMS6100 manufactured by SII.

With regard to the measurement conditions therefor, a sample piece having a width of 6 mm was held in a sample holder, and the measurement length was set at 10 mm. The thickness was measured separately. Heating was carried out at a rate of temperature increase of 4° C./min from −30° C. to 50° C., and during this process the dynamic viscoelasticity at 100 Hz with a maximum strain rate of 0.1% was measured in tensile mode. The system was calibrated by determining the difference between the temperature indicated by a thermocouple affixed to the sample piece and the temperature indicated by the system, and the storage modulus (E′) at 100 Hz and 25° C. was determined.

Furthermore, with regard to the softening temperature, the peak temperature of the loss tangent (tanδ) in a dynamic viscoelasticity measurement at 1 Hz when heated from 60° C. to 200° C. was defined as the softening temperature (Tm). Where there was no peak value for the loss tangent from 60° C. to 200° C., the softening temperature (Tm) was defined as being at least 200° C.

Measurement of the maximum tensile elongation L (%) at break at 25° C. was carried out using a digital force gauge (FGP-5, Nidec-Shimpo Corporation). With regard to the measurement conditions therefor, a sample piece having a width of 6 mm and an initial sample length of 20 mm was elongated at a rate of 5 mm/min, and the sample elongation and the input force were measured. The thickness was measured separately. The maximum elongation when the sample broke was recorded, and the average value of three measurements was defined as the maximum elongation L (%). This measurement was carried out in accordance with JIS K6251.

All of the above-mentioned measurements were carried out in a laboratory that was controlled at a room temperature of 23° C. to 25° C. and a humidity of 40% to 60%.

### <Engraving Method>

Halftone dots with a dot diameter of 20.2 μm, a dot gap of 100.6 μm, and an engraving depth of 120 μm were engraved using a Helios 6010 laser engraving machine (Stork). The engraved shape was subjected to the rinsing step below, the halftone shape was then three-dimensionally measured using a VK-8710 laser microscope (Keyence Corporation), and the inclined face angle was determined.

### <Rinsing Method>

A rinsing liquid was prepared by mixing water, a 10 wt % aqueous solution of sodium hydroxide, and betaine compound (1-B) below so that the pH was 12 and the content of betaine compound (1-B) was 1 mass % of the total rinsing liquid.

The rinsing liquid thus prepared was dropped (about 100 mL/m²) by means of a pipette onto a plate material engraved by the above-mentioned method so that the plate surface became uniformly wet, and it was allowed to stand for 1 min and rubbed using a toothbrush (Clinica Toothbrush Flat, Lion Corporation) 20 times (30 sec) in parallel to the plate with a load of 200 gf. Subsequently, the plate face was washed with running water, moisture of the plate face was removed, and it was dried naturally for approximately 1 hour.

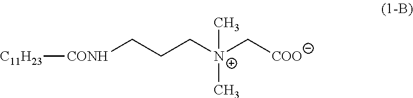

### (Evaluation)

### <Residue Removability>

A 5 cm×10 cm engraved flexographic printing plate was evenly sprayed with 0.5 mL of a rinsing liquid all over, allowed to stand for 3 minutes, lightly brushed with a horse hair brush to wash away engraving residue, and then rinsed with water.

Unremoved residue on the plate was evaluated by examining the rinsed plate surface using a 100× magnification microscope (Keyence). The evaluation criteria were as follows.

Poor: residue adhering to the entire plate face.
Fair: slight residue remaining on projecting parts of plate image, and some residue remaining in bottom parts of image (recessed parts).
Good/fair: slight residue remaining on projecting parts of plate image, and slight residue remaining in bottom parts of image (recessed parts).
Good: slight residue remaining only in bottom parts of image (recessed parts).
Excellent: no residue at all remaining on plate.

### <Engraved Shape (Smallest Point Shape) Measurement>

An engraved flexographic relief plate was measured three-dimensionally using a laser microscope, and the inclined face angle of a small dot (smallest point) was measured.

The angle of inclination (inclined face angle) 0 was preferably 45° to 88°, more preferably 60° to 86°, and particularly preferably 70° to 84°.

### <Printing Method>

A relief printing plate that had been obtained was set in a printer (type ITM-4, Iyo Kikai Seisakujo Co., Ltd.), printing was carried out using the aqueous ink Aqua SPZ16 rouge (Toyo Ink Mfg. Co., Ltd.) as an ink without dilution and Full Color Form M 70 (Nippon Paper Industries Co., Ltd., thickness 100 μm) as a printing paper.

### <Method for Evaluation of Printing>

### (Small Point Width Enlargement)

The printing pressure obtained when pressing by 50 μm from the printing pressure at which halftone ink started to become attached was defined as the standard printing pressure, and the width enlargement (μm) of the halftone print small point diameter per μm of printing pressure when the printing pressure was increased in the range of +20 and −20 μm of the standard printing pressure was defined as the small point width enlargement. The smaller the value, the better.

### <Solid Printed Area Reflection Optical Density>

Measured using a SpectroEye spectrophotometer (X-Rite). The larger the value, the better.

### <Frequency of Occurrence of Small Point Breakage>

Printing was carried out as a 1 cm square 2×2 dot halftone area with the standard printing pressure repeatedly 100 times, halftone dot images from the first time and the 100^{th} time were compared, the number of halftone dots that had disappeared was counted, the proportion relative to the total number of halftone dots was determined, and this was defined as the frequency of occurrence of halftone dot breakage. It was confirmed by examination, using an optical microscope, of a relief halftone dot relative to a halftone image dot that had disappeared that the halftone dot was damaged.

A frequency of occurrence of small point breakage of less than 0.1% was evaluated as excellent, at least 0.1% but less than 0.5% as good, at least 0.5% but less than 2.0% as fair, and 2% or greater as poor.

TABLE 2

| | | | | | | Printing performance | | | |
|---|---|---|---|---|---|---|---|---|---|
| | Plate physical properties | | | | | | | Frequency of | |
| | Mechanical | | Thermal | | Smallest | Solid printed | | occurrence | |
| | physical | | physical | | point shape | area | | of small | |
| Ex. or | properties | | properties | | Inclined face | reflection | | point | Residue |
| Comp. Ex. | E′ | L | Td | Tm | angle | optical | Small point | breakage | removability |
| (C) | MPa | % | ° C. | ° C. | Degrees | density | enlargement | Relative | Relative |
| 1 | 10 | 45 | 200 | >Td | 80 | 1.61 | 0.35 | Excellent | Excellent |
| 2 | 15 | 60 | 200 | >Td | 80 | 1.6 | 0.3 | Excellent | Good |
| 3 | 1.5 | 50 | 210 | >Td | 80 | 1.64 | 0.45 | Excellent | Good |
| 4 | 16 | 50 | 220 | >Td | 80 | 1.61 | 0.3 | Excellent | Excellent |
| 5 | 8 | 70 | 230 | >Td | 80 | 1.63 | 0.35 | Excellent | Excellent |
| 6 | 12 | 70 | 190 | >Td | 80 | 1.62 | 0.35 | Excellent | Excellent |
| 7 | 25 | 35 | 200 | >Td | 80 | 1.59 | 0.25 | Excellent | Excellent |
| 8 | 13 | 80 | 190 | >Td | 80 | 1.6 | 0.3 | Excellent | Good |
| 9 | 27 | 40 | 240 | >Td | 70 | 1.58 | 0.25 | Excellent | Good |
| 10 | 10 | 100 | 200 | >Td | 80 | 1.62 | 0.35 | Excellent | Excellent |
| 11 | 28 | 35 | 200 | >Td | 80 | 1.57 | 0.25 | Excellent | Excellent |
| 12 | 25 | 70 | 220 | >Td | 75 | 1.58 | 0.25 | Excellent | Fair |
| 13 | 18 | 90 | 230 | >Td | 70 | 1.6 | 0.3 | Excellent | Good/Fair |
| 14 | 28 | 180 | 210 | >Td | 75 | 1.57 | 0.25 | Excellent | Fair |
| 15 | 20 | 220 | 300 | >250 | 75 | 1.6 | 0.3 | Excellent | Good |
| 16 | 8 | 260 | 350 | >250 | 70 | 1.63 | 0.4 | Excellent | Good |
| C17 | 35 | 20 | 250 | 150 | 50 | 1.49 | 0.2 | Fair | Poor |
| C18 | 32 | 20 | 210 | >Td | 80 | 1.52 | 0.2 | Poor | Fair |
| C19 | 90 | 100 | 240 | >Td | 70 | 1.34 | 0.15 | Excellent | Fair |
| C20 | 0.7 | 25 | 230 | >Td | 80 | 1.62 | 0.6 | Fair | Fair |
| C21 | 45 | 20 | 200 | >Td | 80 | 1.42 | 0.2 | Poor | Excellent |
| C22 | 40 | 25 | 200 | >Td | 75 | 1.45 | 0.2 | Fair | Good |

### EXPLANATION OF REFERENCE NUMERALS AND SYMBOLS

S: support
F: small dot (smallest point)
θ: angle of inclination (°)

1-11. (canceled)

12. A flexographic printing plate precursor for laser engraving comprising, above a support, a crosslinked relief-forming layer formed by subjecting a resin composition comprising a chain-polymerizable monomer (A), a crosslinking agent (B) that crosslinks in a step-growth reaction, and a crosslinkable polymer (C) having a crosslinkable group that reacts with the crosslinking agent (B) to chain polymerization and step-growth crosslinking reactions, the crosslinked relief-forming layer having a storage modulus E (MPa) at a frequency of 100 Hz and 25° C. satisfying the relationship (a) below and having a maximum tensile elongation L (%) at break at 25° C. satisfying the relationship (b) below:
1≦E′≦30 (a)
30≦L≦300 (b).

13. The flexographic printing plate precursor for laser engraving according to claim 12, wherein the chain-polymerizable monomer (A) is a polyfunctional ethylenically unsaturated compound (A1).

14. The flexographic printing plate precursor for laser engraving according to claim 13, wherein the chain-polymerizable monomer (A) is a polyfunctional ethylenically unsaturated compound having a saturated bridged ring structure.

15. The flexographic printing plate precursor for laser engraving according to claim 14, wherein the chain-polymerizable monomer (A) is a polyfunctional ethylenically unsaturated compound having a saturated bridged ring structure of tricyclo[5.2.1.0^{2,6}]decane.

16. The flexographic printing plate precursor for laser engraving according to claim 12, wherein the crosslinking agent (B) that crosslinks in a step-growth reaction is selected from the group consisting of a polyfunctional isocyanate compound (B1), a polyfunctional acid anhydride (B2), and a hydrolyzable silyl group- and/or silanol group-containing compound (B3).

17. The flexographic printing plate precursor for laser engraving according to claim 13, wherein the crosslinking agent (B) that crosslinks in a step-growth reaction is selected from the group consisting of a polyfunctional isocyanate compound (B1), a polyfunctional acid anhydride (B2), and a hydrolyzable silyl group- and/or silanol group-containing compound (B3).

18. The flexographic printing plate precursor for laser engraving according to claim 14, wherein the crosslinking agent (B) that crosslinks in a step-growth reaction is selected from the group consisting of a polyfunctional isocyanate compound (B1), a polyfunctional acid anhydride (B2), and a hydrolyzable silyl group- and/or silanol group-containing compound (B3).

19. The flexographic printing plate precursor for laser engraving according to claim 16, wherein the crosslinking agent (B) that crosslinks in a step-growth reaction is a silanol group-containing compound (B3).

20. The flexographic printing plate precursor for laser engraving according to claim 12, wherein the chain-polymerizable monomer (A) is a polyfunctional ethylenically unsaturated compound (A1) and the crosslinkable polymer (C) has a glass transition temperature (Tg) of at least 20° C.

21. The flexographic printing plate precursor for laser engraving according to claim 20, wherein the crosslinkable polymer (C) is a polyvinyl acetal or acrylic resin having a hydroxy group or an amino group having at least one hydrogen atom bonded to the nitrogen atom.

22. The flexographic printing plate precursor for laser engraving according to claim 21, wherein the crosslinkable polymer (C) is a polyvinyl acetal having a hydroxy group.

23. The flexographic printing plate precursor for laser engraving according to claim 17, wherein the crosslinkable polymer (C) is a polyvinyl acetal or acrylic resin having a hydroxy group or an amino group having at least one hydrogen atom bonded to the nitrogen atom.

24. The flexographic printing plate precursor for laser engraving according to claim 12, wherein the crosslinked relief-forming layer further comprises carbon black.

25. The flexographic printing plate precursor for laser engraving according to claim 12, wherein it further comprises a compound whose conjugate acid has an acid dissociation constant (pKa) of 11 to 13.

26. The flexographic printing plate precursor for laser engraving according to claim 12, wherein the crosslinked relief-forming layer has a thermal decomposition temperature (Td) satisfying the relationship (c) below, and the crosslinked relief-forming layer has a softening temperature (Tm) that is at least 200° C. or satisfies the relationship (d) below:
150° C.≦Td≦350° C. (c)
Td≦Tm (d).

27. The flexographic printing plate precursor for laser engraving according to claim 13, wherein the crosslinked relief-forming layer has a thermal decomposition temperature (Td) satisfying the relationship (c) below, and the crosslinked relief-forming layer has a softening temperature (Tm) that is at least 200° C. or satisfies the relationship (d) below:
150° C.≦Td≦350° C. (c)
Td≦Tm (d).

28. The flexographic printing plate precursor for laser engraving according to claim 27, wherein the crosslinking agent (B) that crosslinks in a step-growth reaction is selected from the group consisting of a polyfunctional isocyanate compound (B1), a polyfunctional acid anhydride (B2), and a hydrolyzable silyl group- and/or silanol group-containing compound (B3).

29. The flexographic printing plate precursor for laser engraving according to claim 17, wherein the chain-polymerizable monomer (A) is a polyfunctional ethylenically unsaturated compound having a saturated bridged ring structure, the crosslinked relief-forming layer has a thermal decomposition temperature (Td) satisfying the relationship (c) below, and the crosslinked relief-forming layer has a softening temperature (Tm) that is at least 200° C. or satisfies the relationship (d) below:
150° C.≦Td≦350° C. (c)
Td≦Tm (d).

30. A process for making a flexographic printing plate comprising a step of laser-engraving the flexographic printing plate precursor for laser engraving according to claim 12, and
a step of washing the laser-engraved printing plate with water or an aqueous solution.

31. The process for making a flexographic printing plate according to claim 30, wherein the aqueous solution comprises an amphoteric surfactant.
